(19) United States
(12) Patent Application Publication
(10) Pub. No.: US 2025/0031740 A1
(43) Pub. Date: Jan. 30, 2025

(54) COMPOSITIONS, METHODS OF MANUFACTURE, METHODS OF USE, AND SYSTEMS RELATING TO PROVISION OF MONOSACCHARIDES FOR ENDURANCE AND OTHER ACTIVITIES

(71) Applicant: Chew CPG Inc., Boston, MA (US)

(72) Inventors: Kyle STUART, Boston, MA (US); Anna T. CAVALIERI, Boston, MA (US); Lucas SOUSA, Boston, MA (US); Jessica HESS, Boston, MA (US); Leslie MORGRET, Boston, MA (US)

(21) Appl. No.: 18/906,513

(22) Filed: Oct. 4, 2024

Related U.S. Application Data
(63) Continuation of application No. PCT/US2023/017493, filed on Apr. 4, 2023.
(60) Provisional application No. 63/327,055, filed on Apr. 4, 2022.

(51) Int. Cl. A23L 29/30; A23G 3/36; A23G 3/42; A23G 3/48; A23L 2/39; A23L 2/52; A23L 29/00

(52) U.S. Cl. CPC A23L 29/30; A23G 3/362; A23G 3/368; A23G 3/42; A23G 3/48; A23L 2/39; A23L 2/52; A23L 29/015; A23L 29/06

(57) ABSTRACT

A food product is provided. The food product may comprise a sugar blend; fat content consisting of less than 2% of solids in the food product by weight; and protein content consisting of less than 8% of solids in the food product by weight. The sugar blend may comprise at least 50% of solids in the food product by weight. The sugar blend may comprise galactose, glucose, and fructose in their respective monosaccharide forms or contained within disaccharides. Glucose, galactose, and fructose, respectively, may each constitute at least 1% of the sugar blend by weight. The food product may be formed as, for example, a gummy/chew, a sports gel, a drink mix, or a hydrated beverage. Methods of manufacture are additionally provided.

### CROSS-REFERENCE TO RELATED APPLICATIONS

This application claims priority to PCT application serial no PCT/US2023/017493 filed on Apr. 4, 2023, which claims priority to U.S. Provisional Patent Application Ser. No. 63/327,055, filed on Apr. 4, 2022, each herein incorporated by reference in their entireties.

### TECHNICAL FIELD

This application relates to food products comprising sugar blends, methods of manufacture, and methods of use thereof. More specifically, this application relates to sports nutrition products comprising significant levels of glucose, galactose, and fructose-including, in some embodiments, disaccharides composed of such monosaccharides—as well as mineral blends. While it is contemplated that certain embodiments disclosed herein-including, for example, powder, gel, drink, and chew/gummy formulations—may be intended primarily for the purpose of sustained energy delivery during exercise, this disclosure is not so limited. For example, embodiments disclosed herein may be used prior to exercise, for recovery, to help maintain blood glucose and insulin levels among diabetics, for rapid hydration, and/or the like.

### BACKGROUND

Exercise performance is impacted by the body's energy stores. Carbohydrates, principally glycogen, are the body's preferred source of fuel for muscular activity during exercise. The body stores glycogen in skeletal muscles, but such storage is limited, and glycogen stores may be depleted during, for example, intense or prolonged endurance exercise. Upon depletion of glycogen, fatigue and exhaustion may occur. Consumption of carbohydrates prior to, during, and after exercise may help prevent, reduce, or delay glycogen depletion by providing a readily available and accessible supply of carbohydrates for muscular activity. The form of carbohydrate ingested-including sugar vs. starch, monosaccharide vs. disaccharide, and the receptor pathway associated with the metabolism of the particular carbohydrate(s) ingested—may impact blood glucose response, insulin responses, other metabolic responses, overall athletic performance, and/or the like.

Sugars. Glucose, fructose, and galactose are three naturally occurring monosaccharides (sometimes referred to as “simple sugars”) that are commonly found in food. These three monosaccharides have the same chemical composition, C₆H₁₂O₆ but vary in chemical structure and accordingly vary in taste (e.g., sweetness) and metabolic impact in the human body. Other monosaccharides include ribose, xylose, and tagatose.

Disaccharides are sugars composed of two monosaccharides bonded together via glycosidic linkage. Sucrose is a well-known disaccharide that breaks down into glucose and fructose in a 1:1 ratio. It is commonly provided in the form of cane sugar and has a familiar sweetness intensity. Isomaltulose is another disaccharide that that breaks down into glucose and fructose in a 1:1 ratio but has a different glycosidic linkage than sucrose.

Lactose is another well-known disaccharide. It is present in high levels in, for example milk and dairy products. Lactose breaks down into glucose and galactose in a 1:1 ratio. Lactose may be readily hydrolyzed into its component monosaccharides by enzymes in the gut, such as lactase. However, in populations with a deficiency or absence of lactase, lactose may substantially remain as a disaccharide during digestion and proceed into the large intestine, where it can cause diarrhea, flatulence, or other gastrointestinal distress.

Maltose is also a well-known disaccharide. It consists of two bonded glucose molecules. It is typically derived from grains, seeds, and other plant components. Trahalose is another disaccharide that consists of two bonded glucose molecules.

Exogenous sugar absorption and metabolism. The body utilizes both exogenous and endogenous sources of energy to fuel exercise and delay exhaustion. Glycogen is the primary source of this energy and is converted to glucose to maintain appropriate blood glucose levels by the body's various metabolic pathways. Under endurance conditions, the body cannot produce sufficient glycogen to replenish its endogenous stores prior to exertion. Thus, once the body shifts from relying on exogenous sources of energy (e.g., ingested carbohydrates) to endogenous sources (e.g., glycogen), there is a limited amount of time before exhaustion occurs. Thus, for example, in endurance sports, there is a need to maintain relatively consistent blood glucose levels to continue to provide the body energy without depleting glycogen stores in the muscles or liver.

The glycemic index is a metric used to classify the impact of consumption of a specific carbohydrate on blood glucose levels. Glucose has a glycemic index of 100. Consumption of solely glucose creates an acute rise in blood glucose as the glucose is absorbed and transported into the bloodstream by intestinal receptors. This may be followed by an acute drop in blood glucose after oxidation, which can result in exhaustion. Glucose is quickly absorbed, but upon its depletion in the blood, which can happen in 30-60 minutes, the body may need to resort to auxiliary carbohydrate stores, mainly glycogen.

Fructose has a glycemic index of 23, which is generally attributable to its slow rate of absorption. The provision of fructose alone may lead to overly sweet products, as the sweetness of fructose is 1.4 times that of sucrose, alone. Additionally, fructose consumption at high levels can cause gastric distress, due to the slower absorption of fructose than that of sugars such as glucose or galactose. For example, in one study, 70% of healthy young adults who ingested 50 g of fructose experienced gastrointestinal symptoms including abdominal pain, bloating, and flatulence.

Lactose has a glycemic index of 46, indicating that consumption of lactose would have a slower and therefore less abrupt impact on blood glucose levels than consumption of glucose alone. Galactose has a glycemic index of approximately 20, attributable to the fact that galactose is converted into glucose in the liver, resulting in a steadier and slower release of that sugar into the bloodstream.

Absorption of glucose, fructose, and galactose in the small intestine occurs through both energy-coupled and non-energy coupled mechanisms. Glucose and galactose are absorbed via co-transport sodium ions via SGLT1 and through facilitated diffusion via GLUT2. Fructose is absorbed through facilitated diffusion via GLUT2 and GLUT5. Unlike glucose, fructose and galactose are absorbed from the small intestine and almost completely metabolized upon first pass through the liver, where they may be converted into a variety of energy-storing compounds, including glucose and glycogen.

The rate limiting step of exogenous glucose oxidation in the body is its absorption, which has been estimated to function at about 1 g/minute. However, exogenous monosaccharide oxidation can be increased to approximately 1.5-2 g/minute by the provision of a combination of glucose and fructose at a ratio of 2:1. This is because fructose can be absorbed using via a receptor pathway separate from glucose. That is, two pathways for absorption and metabolism of glucose and fructose that are not co-extensive.

Despite the similar absorption pathways of glucose and galactose, these two monosaccharides are metabolized differently. Galactose is actively transported into the hepatic portal vein via SGLT1 and GLUT2. The hepatic portal vein transports galactose to the liver and some galactose enters the Leloir pathway. The end-product of this pathway is glucose-1-phosphate, which is then available for glucose production or glycogen storage. Oxidization of ingested galactose is approximately 50-60% slower than oxidization of ingested glucose due to the requirement for metabolism through the liver.

It has been observed that when glucose and galactose are co-ingested, glucose acts as a primary source of exogenous carbohydrate oxidation during the first 60 minutes of exercise and then tapers off, but galactose can act as the primary source of energy in the second 60 minutes of exercise (when consumed 30 minutes prior to exercise). After 60 minutes of exercise, glucose production has been shown to be almost exclusively derived from galactose, via the Leloir pathway.

Further, it should be noted that, carbohydrates, especially those with a high glycemic index, can stimulate the release of insulin, which promotes glycogen synthesis and storage in the liver and muscles.

Others substances are known to improve or otherwise influence glycogen storage. For example, consuming protein, or its components such as creatine or leucine, can also stimulate insulin release, enhance glycogen storage in the muscles, promote glucose uptake, and increase muscle mass and strength. Caffeine has been shown to increase glycogen storage in the muscles by enhancing the uptake of glucose. Omega-3 fatty acids, chromium, and Vitamin D have been shown to enhance glycogen storage in the muscles through several functions. Additionally, ketone bodies like R-1,3-butanediol can serve as an alternative energy source for the brain and other tissues when glucose levels are low. In terms of its impact on glycogen, R-1,3-butanediol has been shown to have a sparing effect on glycogen stores in the liver and muscles, helping the body to rely on ketones as an energy source, which reduces the breakdown of glycogen for energy and may increase liver glycogen levels. This suggests that R-1,3-butanediol may have a preferential effect on liver glycogen storage.

Existing Sports Nutrition Products The range of sports nutrition products are broad and varied. With respect to endurance related products, they include hydrated sports drinks, powdered drink mixes (e.g., for consumer hydration), energy gels, chews/gummies, bars, and other formats and formulations. Despite the large number of products and brands in this space and the substantial market size, no commercially available sports endurance products contain a sugar blend of glucose, galactose, and fructose with more than negligible levels of each—whether in their monosaccharide forms or within corresponding disaccharides.

Most manufacturers of sports nutrition products use a combination of glucose and fructose (and/or corresponding disaccharides)—to the effective exclusion of galactose. Glucose and fructose are typically provided either in their monosaccharide forms, as sucrose, as maltodextrin (a glucose polymer), and/or the like, and rely on the general time-based metabolism of the two monosaccharides. As noted above, the body's absorption and metabolism mechanisms for glucose and fructose are largely independent. Because fructose is more slowly absorbed and metabolized through the liver, fructose may become available for the body for use around the time that the faster-absorbing glucose is reaching depletion.

Despite the widespread presence of lactose in foods and food products, there is limited utilization of lactose and/or galactose in sports nutrition. GoodSport®, a hydrated sports drink, is the only known sports nutrition product intended to be consumed during or before exercise that includes substantial amounts of lactose and/or galactose. GoodSport®, however, does not contain non-negligible amounts of fructose or other sugars that could utilize the GLUT5 receptor during digestion. There is therefore an opportunity to provide a sugar blend containing adequate levels of glucose, galactose, and fructose for endurance and other activities.

Sweetened and unsweetened milk products are sometimes used as recovery beverages in the sports nutrition space. The beverages are advantageous for post-exercise recovery due to their inclusion of carbohydrates, protein, fat and electrolytes. Milk contains both the slow and fast digesting milk proteins, casein and whey, respectively, in addition to sodium, potassium, and lactose, a disaccharide composed of glucose and galactose. Sweetened milk, such as chocolate milk, has significant levels of glucose, galactose, and fructose. While sweetened milk may be appropriate for sports nutrition after exercise, its consumption prior to and during exercise may be ill advised. Sweetened milk has relatively high protein and fat content, especially when considered relative to its low carbohydrate concentration of around 12-24 grams per cup (240 mL). The body cannot metabolize its fat and protein with sufficient speed during exercise. Accordingly, overconsumption or consumption during or before exercise may be likely to cause gastric distress, hindering athletic performance. Further, the total carbohydrate content of a serving of chocolate milk is about 10-25%: If sweetened milk were consumed at the typical rate for endurance athletes (e.g., 60-120 g carbohydrates per hour or more), fluid intake may exceed sweat output, which may cause further gastrointestinal problems and/or lead to undesirably frequent urination.

Dairy Permeate. While milk is relatively low in carbohydrate content, dairy permeate is a higher-carbohydrate dairy industry byproduct that is largely regarded as a waste stream. Dairy permeate may be considered a liquid (or dried) waste product of dairy processing. Typically, permeate is derived from whey extraction (whey permeate) or from milk (milk permeate). Milk permeate and whey permeate are solutions derived from dairy products that have gone through one or several processing steps including, but not limited to, ultrafiltration to remove the majority of protein and fat, leaving behind a solution substantially comprising carbohydrates (substantially lactose) and dairy minerals. Liquid permeate is then often crystalized and spray dried to achieve powder permeate, depending on the intended application. Milk and whey permeates are substantially the same by composition, but their organoleptic properties may differ.

Milk permeate is often dried into a powder using methods such as spray drying, which is then used in a wide range of applications as an alternative for milk powder or skim milk. Permeate powders are also used for milk standardization, to help address the naturally occurring variations in milk composition based on seasonal and regional factors. Milk permeate powder is also utilized in food processing as a bulking agent, as a flavor carrier, to provide Maillard browning to contribute color, and to reduce costs in a variety of processed food products. Its benefits may include reduced hygroscopicity, free-flowing, slightly salty dairy flavor, and delicate pleasant smell. While dairy permeate is sometimes used as a low-cost alternative sweetener in drinks, breads, cakes, pastries, chocolates, confections, cheese, and yogurt, the majority of permeate produced in the US today is used as animal feed and may be characterized as a sugar-rich waste stream. Leveraging this undervalued ingredient may advantageously help reduce food system environmental pollution.

Beyond water content, dairy permeate substantially comprises lactose; dairy protein (≤10% w/w) and substantial dairy minerals-including, but not limited to sodium, potassium, calcium, and magnesium. The body relies on such electrolytes to operate metabolic functions, and these same minerals are lost via sweat and urine during exercise or rest and must be periodically replenished. Milk permeate may contain a sodium concentration of approximately 21 mmol/L and a potassium concentration of 28 mmol/L, making it an advantageous ingredient to supply electrolytes needed for hydration. In most commercially available sports nutrition products, these important electrolytes are typically added using isolated citrates and functional blends. Accordingly, dairy permeate may be leveraged as cost-efficient source of lactose—and, correspondingly, galactose—and key minerals for use in sports drinks. For example, GoodSport® (discussed above) substantially comprises milk permeate that is enzymatically hydrolyzed with a lactase enzyme to make the product more available to a wider range of consumers. Milk permeate has not, however, been utilized in the production of commercially available energy gel, energy chews/gummies, powders, energy beverage, or other products.

Cacao pulp During chocolate production, cacao pods are utilized as a primary ingredient, but cacao pulp, the juice and flesh of the cacao fruit, is typically considered a waste product. Cacao pulp is often discarded during the bean harvesting stage of chocolate making and may be characterized as a sugar-rich waste stream. As such, discarded cacao pulp may act as an environmental pollutant, serving as a substrate for fermentation, and thereby contaminating water, generating heat, generating carbon dioxide, and/or the like.

Cacao pulp, however, has high fructose content versus other fruits. It also possesses a subtle tart floral sweetness that may provide a unique flavor to products. Additionally, it contains potassium, a key electrolyte in sports nutrition. Cacao pulp also contains pectin, fiber, and other polysaccharides which can provide texturizing properties to food formulations, which may reduce the need for added stabilizers or texturizers that could potentially cause gastric activity after consumption. Accordingly, it may be advantageous to utilize cacao pulp as a cost-efficient ingredient in sports nutrition products. Leveraging this undervalued ingredient may advantageously help reduce food system environmental pollution.

Accordingly, it may be advantageous to provide sports nutrition products that include concentrations of glucose, galactose, and fructose (in monosaccharide or disaccharide forms) that provides optimized endurance and optimizes utilization of absorption and metabolic pathways, and that contains negligible, minimal, and/or limited fat and/or protein content to substantially avoid gastric distress and otherwise improve human performance. It may further be advantageous if such sports nutrition products may be produced in formats that are commonly used by endurance and other athletes. It may also be advantageous if such sports nutrition products could include other functional ingredients or additives to expand performance including but not limited to minerals, vitamins, stimulants, nootropics, or other macronutrients. Further, it would be advantageous if such sports nutrition products could be manufactured economically and/or leverage one or more existing food waste streams to source ingredients.

### SUMMARY

The present disclosure provides a description of products, methods of manufacture, and methods of use to, for example, address the perceived problems and needs described above.

In one embodiment, a food product is provided. The food product may comprise a sugar blend; no measurable fat content or fat content consisting of less than 2% of solids in the food product by weight; and no measurable protein content, or protein content consisting of less than 8% of solids in the food product by weight. The sugar blend may comprise at least 50% of solids in the food product by weight. The sugar blend may comprise galactose, glucose, and fructose in their respective monosaccharide forms or contained within disaccharides. Galactose, including monosaccharide galactose and galactose bound in a disaccharide may comprise at least 1% of the sugar blend by weight. Glucose, including monosaccharide glucose and glucose bound in a disaccharide, may comprises at least 1% of the sugar blend by weight. Fructose, including monosaccharide fructose and fructose bound in a disaccharide, may comprise at least 1% of the sugar blend by weight. The ratio of galactose to lactose in the food product may be at least 199:1 by molarity.

The food product may further include electrolytes. The electrolytes may comprise between 0.5% and 6% of solids in the food product by weight. The electrolytes may comprise dairy minerals naturally occurring in dairy permeate. The food product may further include at least one stimulant. The food product may further include fruit solids derived from cacao pulp. Between 0% and 30% of the sugar blend may consist of sucrose by weight.

Between 20%-70%, 40%-60%, and/or 47%-53% of the sugar blend may consist of glucose, including monosaccharide glucose and glucose bound in a disaccharide, by weight. Between 20%-70%, 30%-40%, and/or 36%-42% of the sugar blend may consist of galactose, including monosaccharide galactose and galactose bound in a disaccharide, by weight. Between 5%-40%, 4%-20%, and/or 8%-14% of the sugar blend may consist of fructose, including monosaccharide fructose and fructose bound in a disaccharide, by weight.

In some chew/gummy embodiments, the food product may further include water, the water making up 10%-25% of the food product by weight. The food product may further include hydrocolloids, the hydrocolloids making up between 0.425% and 3.4% of solids within the food product by weight. The ratio of galactose to lactose in the food product may be at least 19:1 by molarity. The food product may include cacao fruit solids.

In some gel embodiments, the food product may further include water, the water making up 30%-40% of the food product by weight. The food product may further include hydrocolloids, the hydrocolloids making up between 0% and 2.9% of solids within the food product by weight. The ratio of galactose to lactose in the food product may be at least 19:1 by molarity. The food product may include cacao fruit solids.

In some drink mix embodiments, the food product may be a dry powder. The ratio of galactose to lactose in the food product may be at least 19:1 by molarity. The food product may include crystalized cacao powder. In hydrated drink mix embodiments, the food product may include water with a ratio of water to solids between 4:1 and 19:1.

In another example, a method of manufacturing a food product or coproduct thereof is provided. The method may include providing a portion of permeate that contains a first portion of lactose, providing a second portion of lactose, combining the portion of permeate with the second portion of lactose into a blend, agitating the blend, pasteurizing the blend, adding lactase enzyme to the blend; hydrolyzing at least 95% of the lactose in the blend into glucose monosaccharide and galactose monosaccharide; and/or pasteurizing the blend into the coproduct.

The method may further include concentrating the coproduct into a syrup and cooling the syrup. The method may further include drying the coproduct into a powder.

The step of providing the portion of permeate further may include providing a portion of fresh whey permeate, fresh milk permeate, or a combination thereof. It may further include hydrating the dry permeate powder with the portion of water to achieve a permeate solution comprising between 60% and 70% water by weight.

The step of providing the second portion of lactose may include providing a portion of dry lactose powder and/or providing a liquid lactose solution with a Brix between 20 and 30. The step of providing the second portion of lactose may include providing a portion of dry lactose powder, providing a second portion of permeate in liquid form, and hydrating the portion of dry lactose powder with the second portion of permeate.

The step hydrolyzing at least 95% of the lactose into glucose monosaccharide and galactose monosaccharide further may further include, hydrolyzing at least 98% of the lactose into glucose monosaccharide and galactose monosaccharide, providing a beta-galactosidase enzyme as the lactase enzyme, and/or providing a portion of NOLA FIT 5500 produced by CHR Hansen as the beta-galactosidase enzyme at a ratio of lactose to beta-galactosidase enzyme, based on molarity, is between 65:1 and 10:1.

The step of hydrolyzing at least 98% of the lactose into glucose monosaccharide and galactose monosaccharide may further include agitating the pasteurized mixture under 200-300 RPM agitation at 30° C.-40° C. for at least 7 hours, agitating the pasteurized mixture under 225-275 RPM agitation at 33° C.-42° C. for at least 10 hours, and/or hydrolyzing at least 99.5% of the lactose into glucose monosaccharide and galactose monosaccharide.

The method may further include providing a portion of additional sugar, the portion of additional sugar and combining the portion of additional sugar with the coproduct. The additional sugar may comprise sucrose and/or fructose. The monosaccharide and disaccharide content of the combination may constitute a sugar blend. Such sugar blend may include between 20%-70%, 40%-60%, and/or 47%-53% of glucose, including monosaccharide glucose and glucose bound in a disaccharide, by weight; between 20%-70%, 30%-40%, and/or 36%-42% of galactose, including monosaccharide galactose and galactose bound in a disaccharide, by weight; and between 5%-40%, 4%-20%, and/or 8%-14% of fructose, including monosaccharide fructose and fructose bound in a disaccharide, by weight.

To manufacture a gummy/chew product, the method may further include providing a portion of fructose-containing components; combining the portion of fructose-containing components with the coproduct to from a mixture; reducing the mixture; providing a fiber solution; combining, blending, and heating the fiber solution and the reduced mixture; and depositing the combined, blended, and heated material into molds. The step of providing a portion of fructose components further may include providing a portion of crystalized cacao powder.

To manufacture a gel product, the method may further include providing a portion of fructose-containing components, combining the portion of fructose-containing components with the coproduct, providing a portion of texturizing compounds, dispersing the texturizing compounds into the combination of fructose-containing components and coproduct, mixing the combination with dispersed texturizing compounds to form the food product, and depositing the food product into at least one metallized pouch.

To manufacture a drink mix product, the method may further include, providing a portion of fructose-containing components that include a first portion of dry solids; providing a second portion of dry solids; and dry mixing the powder coproduct, the first portion of dry solids, and the second portion of dry solids.

### BRIEF DESCRIPTION OF THE DRAWINGS

The accompanying drawings, which are incorporated into and constitute a part of this specification, illustrate several embodiments and aspects of the apparatuses and methods described herein and, together with the description, serve to explain the principles of the invention.

FIG. 1 is a flow chart of an exemplary method of preparing liquid coproduct, in accordance with exemplary embodiments.

FIG. 2 is a flow chart of an exemplary method of preparing a carbohydrate gel from liquid coproduct, in accordance with exemplary embodiments.

FIG. 3 is a flow chart of an exemplary method of preparing a carbohydrate chew from liquid coproduct, in accordance with exemplary embodiments.

FIG. 4 is a flow chart of an exemplary method of preparing a carbohydrate hydration powder from liquid coproduct, in accordance with exemplary embodiments.

FIGS. 5A and 5B are photos of sports chew/gummy and sports gel, respectively, with crystallization, in accordance with exemplary embodiments.

FIGS. 6A and 6B are photos of sports chew/gummy and sports gel, respectively, without crystallization, in accordance with exemplary embodiments.

FIG. 7 is a chart of ingredients and composition analysis for manufactured examples of coproduct, in accordance with exemplary embodiments.

FIG. 8 is a chart of ingredients and composition analysis for manufactured examples of sports chews/gummies, in accordance with exemplary embodiments.

FIG. 9 is a chart of ingredients and composition analysis for manufactured examples of sports gels, in accordance with exemplary embodiments.

FIG. 10 is a chart of ingredients and composition analysis for examples of sports drink mix, in accordance with exemplary embodiments.

### DETAILED DESCRIPTION

The inventors have determined that the provision of appropriate amounts of glucose, galactose, and fructose can create an overall “smoother” curve of exogenous energy provision and oxidation, and avoid and/or mitigate the “crash” commonly associated with dropping blood glucose levels and depleted endogenous energy stores during exercise, and with limited or minimal gastric distress. As explained above, the scientific literature supports the benefit of glucose and fructose in energy delivery systems for sports nutrition. This is reflected in the bulk of commercially available sports nutrition products. Galactose is a slower processed sugar, compared to glucose, because it takes a path to the liver before being converted either to glucose or glycogen that is regulated by and dependent on the current blood glucose levels in the body.

The co-ingestion of glucose and galactose can spare the body's glycogen stores during exercise by utilizing galactose for glucose production after the ingested glucose has been utilized by the body. In other words, a combination of the glucose and galactose can provide initial energy from glucose followed by energy from galactose to glucose in the liver. However, where galactose and glucose are co-ingested without the addition of fructose (as occurs with GoodSport®, discussed above), the GLUT5 fructose receptor remains unutilized. A potential for a higher overall carbohydrate absorption rate remains.

Thus, by providing a combination of fructose, glucose, and galactose, or the like, all potential carbohydrate receptors can be engaged in carbohydrate absorption simultaneously, thereby increasing overall carbohydrate absorption. This leverages the synergistic metabolic relationship of liver sugar regulation activities, where galactose being converted into glucose and subsequently released into the bloodstream is functionally dependent on blood glucose concentration, with high blood glucose concentration leading to galactose being converted into glycogen and low blood glucose concentration leading to galactose being converted into UDP-glucose via the Leloir pathway

Accordingly, disclosed embodiments that comprise combinations of glucose, galactose, and fructose at appropriate relative concentrations leverage the respective benefits of these three sugars. Thus, consumption may cause a more balanced and sustained curve of blood glucose levels during exercise and thereby maximizing effectiveness and improvements to athletic performance.

Product Composition. Embodiments of the disclosed food product may comprise a sugar blend that consists of, substantially consists, or comprises of glucose, galactose, and fructose. These simple sugars may be provided in their monosaccharide form and/or contained within disaccharides or polysaccharides. For example, glucose may be provided as a monosaccharide or via sucrose, lactose, isomaltulose, maltose, trehalose, and/or trehalulose; galactose may be provided as a monosaccharide or via lactose; and fructose may be provided as a monosaccharide or via sucrose, isomaltulose, and/or trehalulose. While polysaccharides, such as dextrins or maltodextrin, comprise glucose, in preferred embodiments, glucose contained within polysaccharides are not considered part of the sugar blend, discussed herein. In alternative embodiments, however, dextrins and other polysaccharides that can quickly and easily by broken down by the body into monosaccharides and/or disaccharides (as compared to more typical polysaccharide) may be considered part of the sugar blend.

In various embodiments, the sugar blend may be provided for human consumption as the only (or primary) caloric composition within a sports nutrition gel, a powdered beverage mix, an energy drink, an energy chew/gummy, an energy bar, bulk sweetener that may be utilized in, for example, a low-to-no-crash confection for snacking (e.g., caramel, chews, chewing gum, etc.) and/or the like.

Various embodiments of the sugar blend may consist of 1-80% glucose, 1-80% galactose, and 1-50% fructose. More narrowly, embodiments of the sugar blend may consist of 20-70% glucose, 20-70% galactose, and 5-40% fructose. More preferably, embodiments of the sugar blend may consist of 40-60% glucose, 30-45% galactose, and 5-20% fructose. Most preferably, embodiments of the sugar blend may consist of approximately 50% glucose, 39% galactose, and 11% fructose, wherein each percentage may vary by up to 1%, 2%, or 3%. The exact and relative amount of glucose, galactose, and fructose may be adjusted, but the above recited and disclosed embodiments reflect the inventors' comprehensive analysis of scientific literature regarding the effects and benefits of these three sugars when consumed alone or co-ingested, and the inventors' resulting extrapolations and predictions.

In various embodiments of the sugar blend, sucrose may comprise 0-50% of the sugar blend by weight. More narrowly, sucrose may comprise 0-30% of the sugar blend by weight. More preferably, sucrose may comprise 0-20% of the sugar blend by weight.

Glucose is the primary C₆H₁₂O₆ form utilized by the body for energy during exercise, and exogenous glucose is rapidly absorbed into the bloodstream, which may, in turn, cause a spike in blood sugar levels and a subsequent insulin release that drops blood sugar levels rapidly. This rapid blood sugar decrease may result in fatigue and other adverse effects. Accordingly, glucose has been combined with other steadier sugars to avoid spikes and crashes during endurance exercise.

Galactose is absorbed quickly through the SGLT1 and GLUT2 receptors, along with glucose, but like fructose, is oxidized more slowly. Galactose is transported to the liver, where it can be converted to glucose and, then, depending on blood glucose levels, may be either stored as glycogen or immediately released into blood circulation. Galactose alone may not sufficient to keep endurance athletes adequately fueled. Without a quick sugar like glucose present, it may take too long for the body to oxidize galactose to stave of fatigue and other adverse effects. Studies have shown that a 1:1 combination of glucose and galactose can provide quick energy in the first hour of exercise from glucose, followed by steadier energy in the second hour of exercise from galactose. Galactose is also a well-studied sugar in the disaccharide form of lactose (with glucose at a 1:1 ratio) in milk, as a recovery beverage; such lactose consumption has been found to improve muscle glycogen restoration even in cases of lower overall carbohydrate intake.

Fructose is absorbed using a separate receptor than glucose and galactose, which allows for a higher overall carbohydrate absorption and the ability to increase C₆H₁₂O₆ consumption during exercise may be substantially increased, for example, from 60 g/hr to 90 g/hr or potentially higher, when co-ingested at a ratio of 20% fructose 80% glucose. Because fructose is absorbed and oxidized slowly, it can provide a steady source of energy over longer periods of exercise. Fructose is absorbed and transported to the liver, where it can stimulate hepatic carbohydrate oxidation, which helps spare muscle glycogen by providing energy from the liver during prolonged exercise. Additionally, fructose can help increase fluid absorption in the intestines, which helps prevent dehydration during exercise. Consuming too much fructose, however, can cause gastric distress, indicating that its intake should be limited.

The relative amounts of glucose, galactose, and fructose within the sugar blend may be adjusted to comport with particular use cases. For example, galactose, as a lower glycemic index monosaccharide and a precursor for glycogen, has been shown to improve glycogen stores in athletes when consumed in preparation or recovery scenarios. Accordingly, increased galactose content relative to reducing glucose and/or fructose may be desired for product embodiments targeted at recovery. Such embodiments may be particularly effective when taken at the start of an extended break after initial exercise before exercise is set to resume, for example, at the start of half time of a soccer match, or between matches at a tournament. As another example, increased glucose relative to galactose and/or fructose may be preferred before or during evening exercise and/or other exercise engaged in before sleep is intended. Such sugar blend embodiments may provide glucose for the exercise session, but reduce the likelihood of high blood glucose levels (e.g., from galactose and/or fructose) during sleep after exercise. Such embodiments may additionally or alternative have relatively higher water and/or electrolyte content relative to sugars to aide in pre-sleep hydration.

Except as specifically noted, in the context of this application and its claims, ratios, percentages, and relative concentrations of ingredients (including sugars, water, and other components) shall be understood to be defined by weight. Additionally, except as specifically noted, ratios, percentages, and relative concentrations of glucose, galactose, and fructose (or other monosaccharides) shall be understood to include these respective sugars regardless of whether they are in monosaccharide form and/or contained within a corresponding disaccharide form (e.g., lactose, sucrose, maltose, isomaltulose, trehalose, etc.), but not within a polysaccharide form.

Carbohydrates and sources: Provision of glucose, galactose, and fructose for the sugar blend may be achieved using various sources and methods. One simple approach includes purchasing isolated food- or pharmaceutical-grade glucose, galactose, and fructose powder and/or syrup. However, this approach may be uneconomical for commercial production, due at least in part to the processes needed to isolate these sugars and/or their corresponding disaccharides.

Lactose is a commonly used ingredient in the food industry. It is often extracted from milk, commonly of bovine origin, but alternatively or additionally originating from goat, sheep, water buffalo, camel, yak, donkey, horse, reindeer, and/or other mammals. As discussed above, lactose is a disaccharide comprising equal parts glucose and galactose, and can be utilized to provide these monosaccharides.

Another source of lactose in the food industry is dairy products and derivatives, including, but not limited to, dairy permeates. Permeates contain lactose, in addition to the naturally occurring minerals and electrolytes present in milk. Such permeates may be commercially provided without significant hydrolysis of lactose, or wherein lactose is at least partially hydrolyzed into galactose and glucose. Lactose sugars may be provided via other whole or powdered dairy products, including, but not limited to, liquid whey and fermented dairy products, such as yogurt or kefir. Such products can provide additional macronutrients such as protein and fat to the composition, depending on the intended use occasion. For example, recovery beverages or other embodiments may include increased or added protein to aid in muscle repair & growth.

In various embodiments, Lactose can be used as-is, used as-is with added enzyme in the product composition, or hydrolyzed into its monosaccharide constituents. Methods for lactose hydrolysis include pH-dependent hydrolysis, where the lactose is buffered in solution to a point where it breaks into its monosaccharide constituents; temperature-induced hydrolysis; catalytically-induced hydrolysis; and enzymatic hydrolysis, where enzymes from yeast, bacterial, fungal, or other sources break down lactose. Enzyme type may be selected depending on the goal of hydrolysis, process conditions or limitations, and/or the mineral composition of the lactose-containing solution. For instance, Kluyveromyceslactis, a yeast-derived beta-galactosidase has a higher tendency to produce galactooligosaccharides in addition to the free monosaccharides glucose and galactose. In some embodiments, native lactose can be provided in conjunction with anhydrous lactase enzyme, which hydrates upon use and then acts on lactose sugars during digestion in the body. Process hydrolysis or added enzymes may permit populations with some or total lactose intolerance to consume lactose-containing products with reduced (or without) adverse effects from undigested lactose in the gastrointestinal tract.

Galactose may also be found in plants, but in very small quantities as compared to dairy sources. Most commonly, galactose in plants exists in polysaccharide forms such as galactan, pectin, hemicellulose, and plant gums such as red seaweed. Fruits and vegetables that contain galactose in some quantities include, but are not limited to, apple, bean sprout, beet, broccoli, corn, kiwi, papaya, persimmon, white potato, sweet potato, and tomato.

Glucose and fructose are found abundantly in nature, largely in plant sources, and often in combination with one another. Some of the most common sources of glucose and fructose in the food industry include sugar cane, sugar beet, and corn, but all fruits and vegetables contain some level of glucose and/or fructose. Fruits high in glucose include, but are not limited to, bananas, grapes, mangoes, pineapples, apples, and pears. Starch and longer-chain polysaccharides are often made up of nearly or completely glucose, so these can be utilized as sources of glucose as well, though larger compounds impact the rate of digestion and therefore oxidation. Vegetables high in glucose include, but are not limited to, sweet potatoes, corn, beets, carrots, corn, and peas. Fruits high in fructose include, but are not limited to cacao, apple, blackberry, sour cherry, fig, plum, lychee, and watermelon. Vegetables high in fructose include, but are not limited to corn, artichoke, tomato, asparagus, leek, fennel, mushroom, okra, onion, pea, bell pepper, shallot, and broccoli. Additional fruits, vegetables, and other plant matter contemplated for use in product embodiments include, but are not limited to, agave, acai, acerola, apricot, avocado, blueberry, breadfruit, brown rice, buckwheat, cabbage, cantaloupe, carambola (starfruit), cherimoya, cherry, citrus, clementine, coconut, cranberry, cucumber, currant, custard apple, date, durian, elderberry, feijoa, fennel, gooseberry, grapefruit, guava, honey, jackfruit, kiwi, leeks, longan, loquat, mandarin, mango, mangosteen, maple, melon, mulberry, mushroom, nectarine, olive, orange, palm, papaya, passion fruit, peach, pear, pepper, persimmon, pineapple, pitaya (dragon fruit), pitanga, plantain, pomegranate, potato, prickly pear, prune, pumpkin, quince, raspberry, rhubarb, rose-apple, rose hip, sapodilla, sapote, soursop, spinach, strawberry, sugar beet, sugar cane, sugar apple, sweet potato, tamarind, tapioca, tomato, and/or turnip.

These and other fruits, vegetables, and or grains may be utilized in the form of juice, juice concentrates, dried powders, pulps, purees, and/or the like.

The selection of fruit or vegetable input sources of glucose and/or fructose may consider the target moisture content of the final product; desired flavor profiles; desired ratio of glucose to fructose; desired polysaccharide content; the potential incorporation of additional non-sugar carbohydrates including but not limited to fiber and oligosaccharides; and/or the like.

Other sources of glucose fructose may include syrups such as honey, agave, molasses, maple, processed syrups such as high-fructose corn syrup, and/or the like.

It should also be noted that longer-chain carbohydrates such as fiber can slow the rate of digestion, which can impact and thereby potentially improve nutrient absorption in the gut. Accordingly, various product embodiments may incorporate non-negligible amounts of fiber, pectin, oligosaccharides, and/or other complex carbohydrates to modulate the satiety and digestion experience of the target user. Such carbohydrates may be present in the food sources listed above, and may thereby be incorporated into product embodiments via inclusion of whole food purees or pulps and/or the like as ingredients. Fiber and/or longer-chain carbohydrate content can be adjusted in view of the target use case, target satiety, and target gastric emptying rate, and/or the like.

Fat and Protein Content. In preferred embodiments of products comprising the sugar blend, fat content and/or protein content may be negligible and/or substantially minimized. Ingestion of high levels of these substances soon before or during exercise can cause gastrointestinal distress, can slow absorption of sugars from the digestive tract, and/or otherwise hinder comfort or athletic performance. Further, certain consumers may prefer to avoid additional fat in their diet. Accordingly, certain product embodiments may contain less than 2% fat content, more preferably less than 1% fat content, even more preferably less than 0.3% fat content, and most preferably less than 0.1% fat content. Similarly, certain product embodiments may contain less than 8% protein content, more preferably less than 5% protein content, even more preferably less than 2% protein content, and most preferably less than 1.5% protein content. However, certain consumers desire protein in their sports nutrition products, including, for example, energy bars. Higher protein content (and fat) may stave off hunger for extended periods of time. And the inclusion of significant amounts of protein may advantageously stimulate insulin release, enhance glycogen storage in the muscles, promote glucose uptake, and increase muscle mass and strength. Accordingly, some embodiments may contain significant amounts of protein (and/or fat).

Electrolytes. In addition to carbohydrates, athletic performance and metabolism, especially during endurance activities, are dependent on the presence and utilization of mineral electrolytes, which provide ions when dissolved in water. Electrolytes are lost in sweat during endurance activities and replenishment is desirable. Sources of these electrolytes include commercially-available mineral salts, sea salt, citrates and functional blends, mined salt, and whole foods, including, but not limited to, dairy permeates and cacao pulp, which naturally contain a complex of electrolytes.

Various product embodiments may comprise an electrolyte blend. The electrolyte blend may include dairy salts, and other added salts. In various embodiments, such electrolytes may consist of 0-10% of the total product solids by weight. More narrowly, such electrolytes may consist of 0.5-6% of the total product solids by weight. Most preferably, such electrolytes may consist of 1-4% of the total product solids by weight.

### Additional Ingredients

Embodiments of the sugar blend-containing product may include vitamins such as, but not limited to vitamin A, B vitamins, vitamin D, and antioxidants such as vitamin C. The provision of vitamins may further improve athletic performance and health. Notably, vitamin B6 may play an important role in glycolysis and glucose oxidation. This vitamin may be provided as an isolated pharmaceutical ingredient; from a derivative of foods where it naturally occurs in relatively high amounts, including, but not limited to, fish, beef liver, organ meats, starchy vegetables, and certain fruits; and/or via a whole food puree, pulp, powder, and/or other like from, for example, suitable fruits like cacao.

Embodiments of the sugar blend-containing product may include hydrocolloids and/or other texturizing agents, which may serve to modify the texture of the product. Hydrocolloids may thicken and impart texture to aqueous dispersions. Possible hydrocolloids within various product embodiments may include, but are not limited to, starches, such as corn, arrowroot, kudzu, tapioca, potato, and/or the like; gums, such as guar, locust bean, karaya, tragacanth, Arabic, and/or the like; and/or gelling hydrocolloids such as alginate, pectin, carrageenan, gelatin, gellan, agar, and/or the like. It is contemplated that hydrocolloids may be added via powders, solutions, and/or whole food ingredients. However, it may be desired to minimize and/or limit the provision of added hydrocolloids to improve digestion via inclusion of purees, pulps, and whole food powders that include pectin, fiber, complex carbohydrates, and/or the like to impart desired texture.

Embodiments of sugar blend-containing products may include added flavorings to improve the consumer experience and create broader appeal. It is contemplated that artificial or natural flavors may be added, as well as acidulants or other pH-modifiers to create various flavor profiles and/or set a preferred pH level for a final product. In preferred embodiments, whole food ingredients, most notably from fruit, may be include in powdered, pureed, and/or liquid forms to impart flavor. It certain embodiments, allulose, a commercially available polyol and non-caloric sweetener, or other non-nutritive sweeteners, such as, but not limited to tagatose, aspartame, sucralose, stevia, saccharin, and/or neotame, may be included for flavor properties and sweetness.

Embodiments of sugar blend-containing products may include stimulants or nootropics. Stimulants and nootropics may provide additional functional and/or cognitive benefits to the body, including improving athletic performance, staving off fatigue during exercise, increasing focus, and/or the like. Accordingly, certain embodiments may include metabolically significant amounts of caffeine, ginseng, Rhodiola rosea, taurine, theobromine, theophylline, 1-theanine, cordyceps, schizandrol A, maca root, pine pollen, curcumin, catechin polyphenols, yerba mate, guayusa, guarana, willow bark, tea extract, and/or the loke. Other stimulant compounds including yohimbe, bitter orange, Ginkgo biloba, and octopamine may additionally or alternatively be utilized in certain product embodiments; however, inclusion of such substances in detectable amounts may have negative implications for athletes who are required to undergo testing for banned substances in competition.

Certain embodiments of sugar blend-containing products may include cannabinoids and/or related compounds. Cannabinoids derived from cannabis plant matter and/or other natural or artificial sources may provide psychoactive and/or non-psychoactive therapeutic effects, including, but not limited to euphoria, anti-inflammatory, pain relief, sleep, neuroprotection, and anti-nausea. Accordingly, certain product embodiments may include metabolically significant amounts of one or cannabinoids including, but not limited to, tetrahydrocannabinol (THC), cannabidiol (CBD), cannabinol (CBN), cannabigerol (CBG), cannabichromene (CBC), tetrahydrocannabinivarin (THCV), cannabidiolic acid (CBDA), and/or the like. Inclusion of such substances may have negative implications for athletes in competition who are required to undergo testing for banned substances in competition. Additionally, it should be noted that such substances may be illegal or highly regulated in certain jurisdictions. Thus, care should be taken to minimize legal risk and comply with appropriate law and regulation, in sourcing, manufacturing, marketing, selling, and consuming such product embodiments.

Certain embodiments of sugar blend-containing products may include Omega-3 fatty acids, chromium, ketone bodies (including, but not limited to R-1,3-butanediol) to, for example, enhance glycogen storage and/or provide additional energy source(s).

It is contemplated that, in various product embodiments, each serving may include between 10 g and 60 g of sugar blend, along with an appropriate amount of electrolytes. Such recommended serving sizes may depend on the consumption occasion (e.g., before, during, or after exercise); the intensity and duration of exercise, the user's weight and state of physical fitness, the user's subjective assessment of current condition (e.g., fatigued, hungry, etc.), amounts of other food ingredients including in the product (e.g., complex carbohydrates, protein, etc.) and/or the like. It is contemplated that typical serving sizes for endurance sports may be 15 g-125 g sugar blend embodiment per hour of endurance sport activity, or more preferably 60 g-90 g sugar blend embodiment per hour of endurance sport activity. The exact consumption is dependent upon individual needs, but the full-spectrum sugar profile of the preferred embodiment allows individuals to consume and absorb 1.5 g/kg/hr.

### Coproduct Embodiments and Preparation Thereof

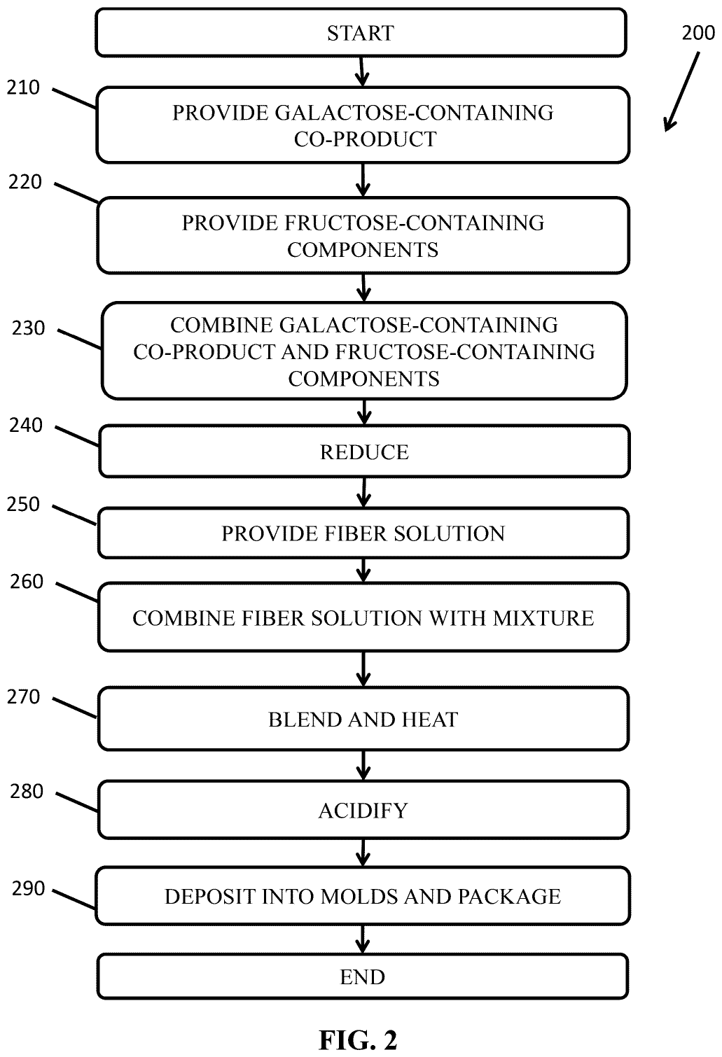

As discussed in more detail below (e.g., with reference to FIGS. 2-4), preferred embodiments of making sports nutrition products comprising the sugar blend embodiments utilize a specialized coproduct containing significant amounts of galactose and glucose. Embodiments of the galactose-containing coproduct may contain substantially all of the galactose included within the final sugar blend, along with an equivalent amount of glucose. Preferred sugar blend embodiments, and products thereof, include additional fructose, often alongside additional glucose. Preferred product embodiments may further include substantial amounts of electrolytes, a negligible or amount of fat, a negligible or limited amount of protein, and/or a limited amount of unhydrolyzed lactose. In certain preferred embodiments, at least 99.5% of lactose is hydrolyzed, such the ratio of galactose in monosaccharaide form to galactose as a component in lactose is 199:1 or better.

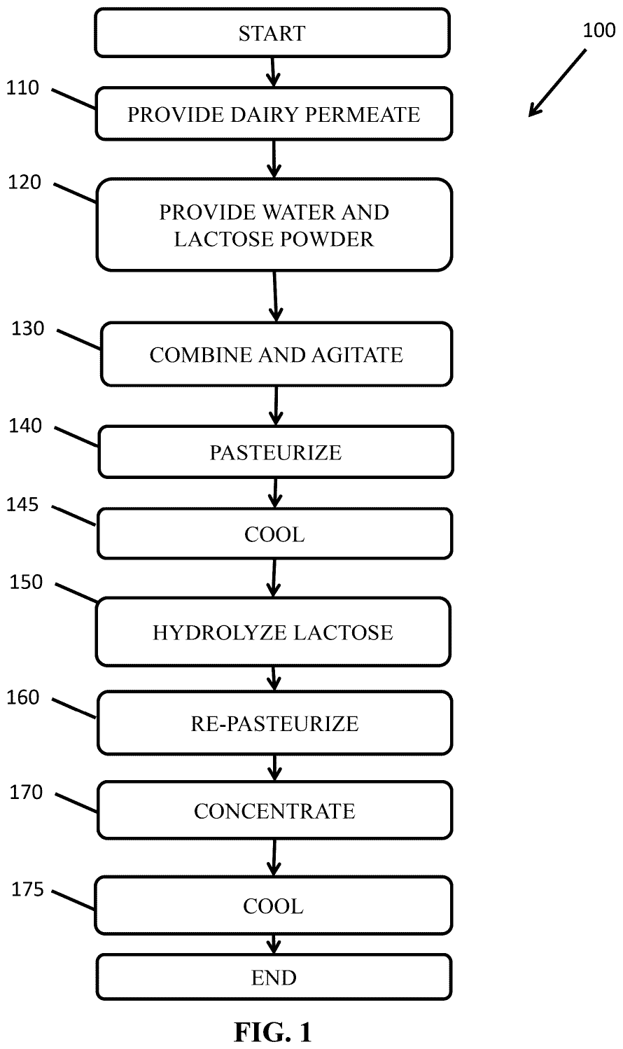

With reference to FIG. 1, an embodiment of a method 100 for preparing a coproduct containing readily available galactose and glucose is provided. As would be appreciated by one of skill in the art, various galactose-containing coproduct embodiments may be utilized to, for example, make food product embodiments in accordance with FIGS. 2-4. Accordingly, portions of this and other methods disclosed herein comprise methods for manufacturing embodiments of food product with disclosed sugar blend embodiments.

As in step 110, dairy permeate may be provided. In one embodiment, dairy permeate may be provided hot, for example, at or around 48.8° C. (e.g., 46° C.-51° C.), to expedite subsequent mixing steps. The permeate is preferably fresh in liquid form, but may also be provided as a non-fresh liquid or via dried powder that must be dissolved in water or otherwise reconstituted. In preferred embodiments, the permeate may be relatively low in both protein and fat, having been extracted from such components during its production. The method may proceed to step 120.

As in step 120, lactose powder and water may be provided. The provided water may preferably be purified via reverse osmosis and/or or the like. Additionally or alternatively, a pre-formulated lactose-water or liquid lactose solution may be provided. In various embodiments, such liquid lactose solution may have Brix of between 6 and 70, more narrowly between 10 and 50, and preferably between 20 and 30.

The inventors have observed that the ratio of total sugar to dairy minerals within dairy permeate is typically too high to achieve a desirable ratio of sugar blend to electrolytes in a final product without additional ingredient manipulation. For example, extensive experimentation revealed that, when permeate is the sole (and/or majority or predominant) source of lactose, the high mineral content of permeate may impart a negative flavor impact in the final downstream products. The permeate to added lactose ratio may be adjusted depending on the final embodiment preferred, particularly when considering the desired mineral and electrolyte content in the final embodiments in which the sugar blend will be prepared. The inventors determined that a hydrolyzed 50/50 blend of lactose solution and permeate serves to control the mineral content, while maintaining appropriate sugar content. Thus, the provision of additional lactose beyond that naturally occurring in dairy permeate enables achievement of a desirable sugar blend to electrolyte ration in an economic fashion.

As noted above, preferred embodiments of the coproduct base solution may comprise approximately 50% lactose from whey and/or milk permeate and approximately 50% added lactose. More broadly, embodiments of the coproduct base solution containing 25-75% lactose from whey and/or dairy permeate and approximately 25-75% added lactose are specifically contemplated. However, this disclosure is not so limited: In alterative embodiments, the coproduct base solution may be derived from entirely from whey and/or milk permeate, entirely from lactose (in solution), or entirely from another dairy source. In yet other embodiments, two or three of these sources may be combined in various amounts to arrive at suitable coproduct base solution.

The method may proceed to step 130.

As in step 130, the permeate and lactose solution (or components thereof) are combined and agitated. In one example, these ingredients may be transferred to a jacketed mixing vessel, for example, with approximately 500 gallon capacity. The mixture may be agitated via, for example, 230-300 RPM side sweep agitation, to accelerate mixing time and achieve homogeneity. Further, the mixture may be recirculated, ensuring that all solids (e.g., lactose powder) are dissolved. In one example, the recirculation may be effectuated via a grate-covered batch tank and centrifugal pumps. The method may proceed to step 140.

As in step 140, the mixture may be pasteurized to, for example, prevent (or substantially reduce) undesirable microbial proliferation in later steps that could contaminate the product and/or compete for resources with later added enzyme. In one example, the mixture was pasteurized to 77-85° C. for 15-30 seconds. In one example, the mixture was re-pasteurized to 77.8° C. for a minimum of 15 seconds. A plate heat exchanger may be used. The method may proceed to step 145.

As in step 145, the pasteurized mixture may be cooled to facilitate lactose hydrolysis. This may help prevent (and/or substantially reduce) the preferred enzyme from being thermally inactivated prior to (and/or during) hydrolysis. In one example, the coproduct is cooled to approximately 35° C. using a horizontal, cool air circulated agitation tank. The method may proceed to step 150.

As in step 150, the lactose within the mixture may be hydrolyzed, preferably to at least 99.5% in accordance with target final residual lactose content to reduce or avoid lactose-related gastric distress. In one example, the coproduct is transferred to a 35° C. jacketed, closed-lid, hydrolysis tank under 250 RPM agitation, where the beta-galactosidase enzyme was introduced using a sanitized centrifugal pump. In such example, the mixture is maintained under such conditions then hydrolyzed for 10 hours or until hydrolysis reaches ≥99.5%.

Because of the high solids content, substantial experimentation was required to determine ideal and appropriate usage rates of lactase enzymes to break down the lactose effectively and efficiently. Higher success of lactose hydrolysis may generally be considered beneficial for populations that have difficulty breaking down disaccharide lactose in their gut. Higher rates may also enable a ‘lactose free’ claim when marketing product embodiments to consumers.

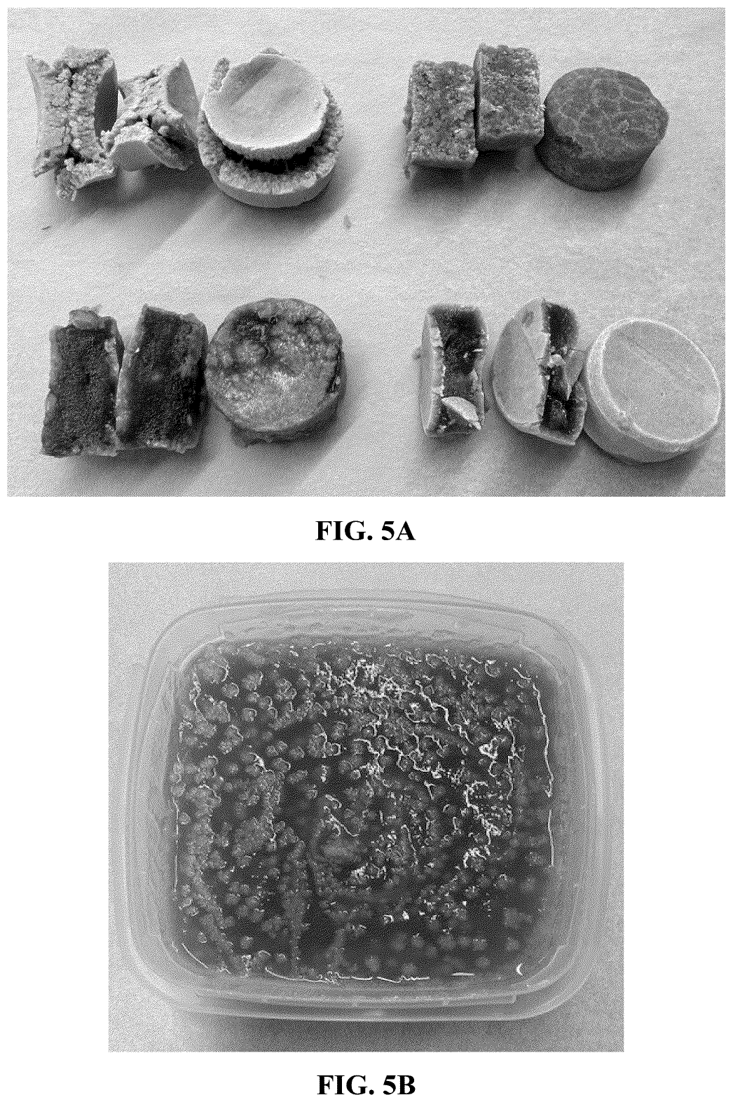

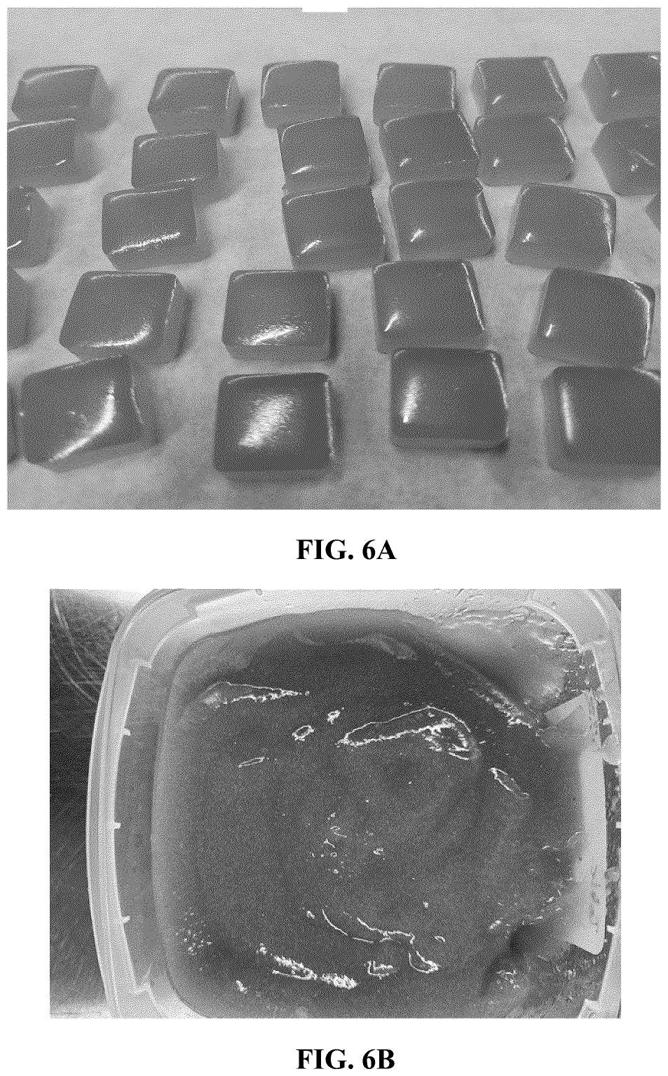

The inventors have determined that achieving lactose hydrolysis at or around 99.5% or more is also important for production of certain commercially-desirable sports nutrition products that contain embodiments of the sugar blend disclosed herein. More specifically, initial attempts to manufacture sports gels and sports chew/gummies based on the sugar blend embodiments resulted in product crystallization, as shown in FIGS. 5A (gummy/chew) and 5B (gel). After approximately 200 trials—wherein monosaccharides, disaccharides, and other ingredients were successively substituted and their concentrations modified in various combination, the inventor determined that the presence of residual lactose, with its prism-type disaccharide structure, had been seeding crystallization in the food matrices of food and gummy embodiments. The inventors ultimately determined that a lactose hydrolysis rate of 99.5% of better was a key factor in preventing crystallization when such is desired in the preferred embodiments. The inventors also determined from these studies that, for chew/gummy embodiments, avoiding crystallization also required attention to pH, and limiting the inclusion of longer carbohydrate chains and pectin. As shown in FIGS. 6A (gummy/chew) and 6B (gel), product embodiments that incorporate high levels of sugar blend produced through method 100 (and its >99.5% lactose hydrolysis) reveal no more than negligible crystallization. Lower than 99.5% lactose hydrolysis may also lead to crystallization during processing and therefore increased viscosity of the sugar blend itself, which can impact the processing and handling of said ingredient. As such, increasing hydrolysis allows for a more readily flowable product.

In other embodiments, more unhydrolyzed lactose may be desired, for example, if a crystallized texture (e.g., chewy, taffy-like, or fudge-like) is preferred, if a ‘lactose-free’ statement or claim is not required or desired, and/or if a different perceived sweetness is desired. In such embodiments, hydrolysis rates lower than 99.5%, and even as low as 0%, may be acceptable. It may also be noted that crystallization is unlikely to be disadvantageous in powder embodiments. In certain embodiments, at least 99%, 98%, 97%, 96%, or 95% of lactose is hydrolyzed, such the ratio of galactose in monosaccharaide form to galactose as a component in lactose is 99:1, 49:1, 97:3, 24:1 or 19:1, respectively, or better.

The inventors ultimately identified NOLA FIT 5500 produced by CHR Hansen as a commercially viable and effective enzyme. The Hansen lactase enzyme advantageously splits lactose into D-glucose & B-Galactose without the production of galactooligosaccharides, which can cause gastrointestinal distress by fermenting in the lower intestine.

Supplier documentation, however, taught away from achievement of preferred hydrolysis rates. Such documentation focuses on lower total hydrolysis rates and lower total solids contents during hydrolysis than what was required and/or desired for the disclosed invention, as typical lactose hydrolysis efforts are focused on whole food applications such as milk or yogurt, where total sugar content is 10-20%, and the percent hydrolysis required to active ‘lactose-free’ claim levels is much lower than 99.5%, typically around 70%. With these commercial standards, the invention's needed were outside the supplier's documentation and recommendations, and therefore required novel experimentation to achieve target residual lactose levels. In many trials, the inventors were ultimately able to reach the desired >99.5% hydrolysis on a 31.5% lactose solution using 0.5-3% total enzyme in the solution (65:1 to 10:1 ratio of lactose:beta-galactosidase enzyme, based on molarity).

Notably, the inventors determined that agitation was an unexpected factor that influenced the hydrolysis rate. Repeated experimentation revealed that low shear agitation was important to the hydrolysis process. It was experimentally determined that, without agitation (e.g., samples dosed with sufficient lactase enzyme, vacuum sealed, and placed in a water bath), sufficient hydrolysis occurred when lactose solids remained low (e.g., up to around 6%), but did not occur with higher lactose/permeate solids concentrations (e.g., 25-65%). In another set of experiments, utilization of a high shear blade (e.g., in a Thermomix heated mixer) during hydrolysis resulted in precipitation of coagulated protein (e.g., substantially including the lactase enzyme) from the solution and incomplete hydrolysis. The inventors determined that consistent but gentle agitation (e.g., magnetic stirrer @ 1200 rpm) and 5% concentration of Hansen lactase enzyme resulted in target hydrolysis (>99.5%) of higher initial lactose content (25-65%). It was determined that such agitation improved surface area contact of the Hansen lactase enzyme with the substrate (lactose or whey permeate). It should be noted, however, that a 5% enzyme concentration may be too high for economic production at high volume.

After approximately 100 attempts experimenting with lactose concentration, various enzymes, agitation characteristics, temperatures, and reaction times, the inventors relied on the reproducible and economically viable step to achieve >99.5% hydrolyzation that is disclosed herein.

The method may proceed to step 160.

As in step 160, the mixture may be pasteurized once more, to inactivate any residual lactase enzyme. In one example, the step may proceed in accordance with step 140, above. The method may proceed to step 170.

As in step 170, the mixture may be concentrated to remove some water content and provide a syrup, paste, or other solid for incorporation into various embodiments. In one embodiments, the mixture is transferred to a five-stage falling film evaporator system (e.g., set to 79.4° C.) and concentrated to 65-85% solids, or 65-85° Brix, preferably 65° Brix. Removing this excess moisture and bringing the sugar blend to a 65° Bx or higher concentrated solution allows downstream formulation to occur more efficiently, as added solids in preferred embodiments can slow the cooking time.

In alternative embodiments, for example, when the final product is a liquid beverage embodiment, step 170 may be omitted. For example, fructose-containing components and other ingredients could be added to the liquid coproduct-either while hot or after cooling (e.g., step 175). However, in most manufacturing embodiments, reduced initial moisture content in the coproduct (e.g., from concentration step 170) may be preferred to simplify manufacturing processes, for ease of transport, for ease of storage and/or the like.

The method may proceed to step 175.

As in step 175, the concentrated coproduct may be cooled to facilitate packaging in primary packaging, storage, and/or utilization in subsequent manufacturing processes. In one embodiment, the sugar blend may be held at ambient temperature until it reaches 50-55° C. The sugar blend may then be packaged into totes or supersacs, and stored ambient or refrigerated, preferably refrigerated. Certain concentrated liquid coproduct embodiments may comprise between 60%-70% of water by weight, and/or preferably approximately 65% water by weight. More broadly, certain liquid coproduct embodiments may comprise between 50% and 95% water by weight Method 100 may be completed.

In some embodiments, depending on the lactose hydrolysis rate and subsequent viscosity of the coproduct, subsequent removal of the coproduct from packaging may benefit form agitation using a tote mixer and/or warming through a heating band or bed.

When preparing various coproduct embodiments disclosed herein, it shall be understood that format may be adjusted depending on the process available and the target application, including the ultimate product form ultimately intended. For example, after the coproduct is substantively prepared (e.g., through step 160), it may be provided a concentrated syrup (as in method 100), as a liquid solution (by, e.g., omitting step 170 from method 100), or dried using techniques (e.g., following step 160 or step 170), including, but not limited to, spray drying, freeze drying, fluid bed drying, drum drying, vacuum-assisted drying, microwave-assisted drying, or solvent extraction.

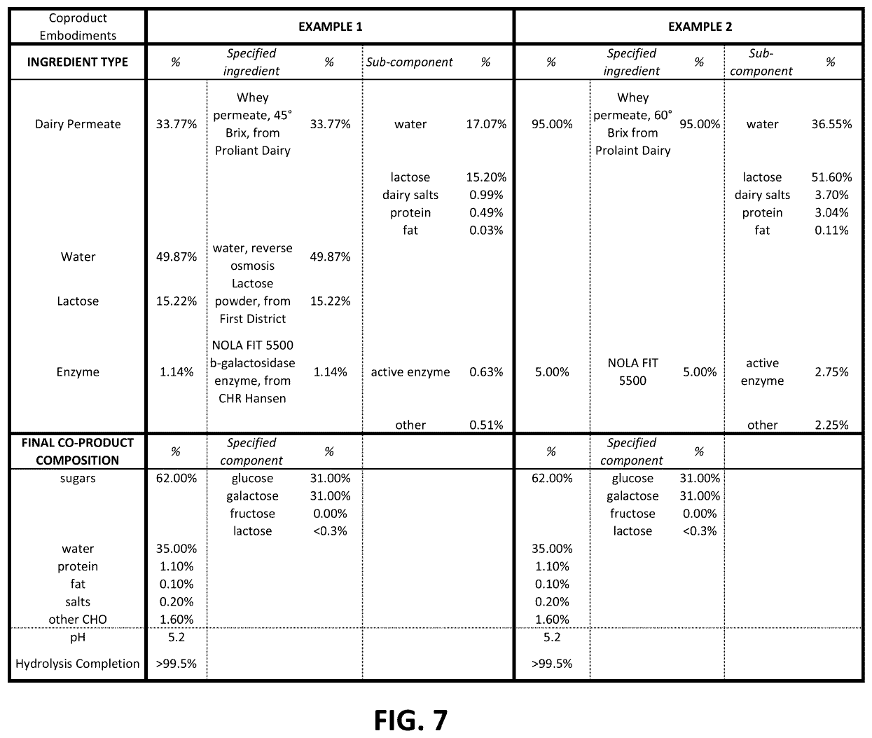

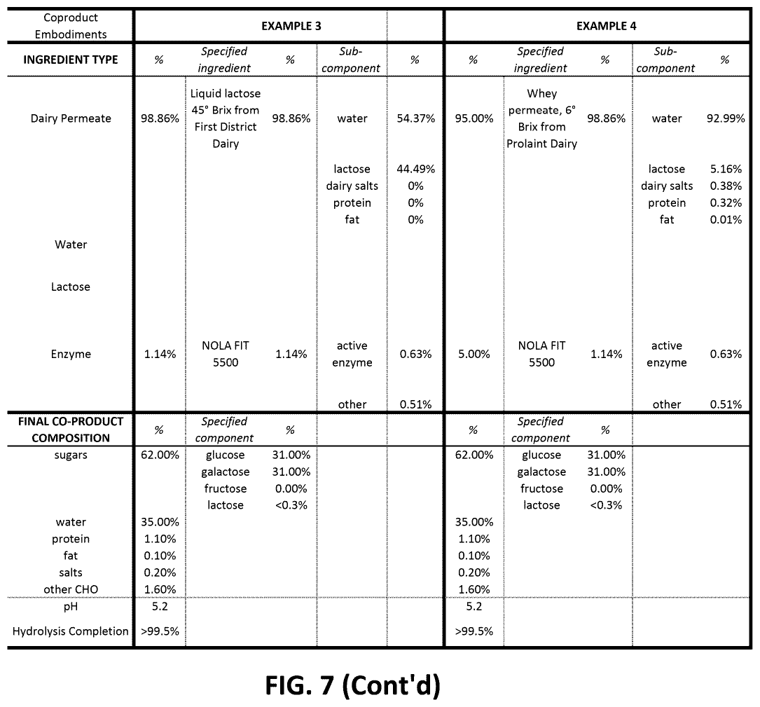

FIG. 7 provides examples of ingredients utilized for manufacturing coproduct and the final coproduct composition, consistent with embodiments of method 100. It may be noted that the protein content of these exemplary final coproduct composition substantially consists of denatured lactase enzyme and residual proteins from the permeate. It may also be noted that Example 2 is made from a method 100 embodiment that omitted steps 120 and 130.

In various embodiments of liquid coproduct, the pH may be between 4.0 and 7.0; more narrowly, a desired pH may be between 4.5 and 6.0; more preferably, a desired pH may be between 5.0 and 5.6.

### Energy Chew/Gummy Embodiments and Preparation Thereof

Certain energy chew embodiments may substantially comprise 30-85% lactose solids and derivatives, 5-30% fruit solids and/or added sugars, 0-4% salts and other electrolytes, 0-50% water, 0-5% hydrocolloid, and/or 0-1.5% caffeine and/or other stimulant. More narrowly, embodiments of the energy chew embodiments may substantially comprise 45-75% lactose solids and derivatives, 8-25% fruit solids and/or added sugars, 0.1-3% salts and other electrolytes, 10-20% water, 0.25-3% hydrocolloid, and/or 0.1-1% caffeine and/or other stimulant. More preferably, embodiments of the energy chew embodiments may substantially comprise 55-70% lactose solids and derivatives, 10-20% fruit solids and/or added sugars, 0.2-2% salts and other electrolytes, 10-15% water, 0.3-2% hydrocolloid, and/or 0.15-0.2% caffeine and/or other stimulant.

With reference to FIG. 2, an embodiment of a method 200 for preparing an energy chew/gummy is provided. As would be appreciated by one of skill in the art, portions of this and other methods disclosed herein comprise methods for manufacturing embodiments of food product with disclosed sugar blend.

As in step 210, galactose- and glucose-containing coproduct may be provided. In preferred embodiments, such sugar blend may be provided in liquid or syrup form. In some embodiments step 210 may comprise method 100 or the like. In alternative embodiments, the coproduct may be provided in a powdered or other dried or partially dried form; in such circumstances, the coproduct may require hydration in or prior to step 210 to achieve an aqueous solution. In alternative embodiments, a solution comprising galactose, glucose, and/or electrolytes may be utilized in lieu of a coproduct derived from permeate. The method may proceed to step 220.

As in step 220, fructose-containing components may be provided. Such components may additionally contain substantial amounts of glucose. In certain preferred embodiments, isolated sugars, such as sucrose, are utilized. In various embodiments, fructose-containing components may include one or more juices, concentrates, fruit pulps, purees, and/or powders. In some embodiments, cacao pulp, puree, and/or powder may be utilized. In some embodiments, isolated sugars such as fructose, isomaltulose, maltose, and/or trehalulose may be additionally or alternatively provided in this step. In various embodiments, it is contemplated that a manufacturer may select one or more particular fruit extract to meet the target monosaccharide ratios and/or select one or more particular fruit extracts to impart a desired flavor and then isolated sugars to meet the target monosaccharide ratios. The method may proceed to step 230.

As in step 230, the aqueous sugar blend and the fructose-containing components may be combined in, for example, a cooking vessel. In some embodiments, they may be mixed. The method may proceed to step 240.

As in step 240, the combined components may be reduced, by removing water content. In one example, the mixture may be heated to 90-100° C. for 20-50 minutes. The method may proceed to step 250.

As in step 250, a fiber or hydrocolloid solution may be provided. In one example, the fiber or hydrocolloid solution may comprise a hydrated pectin solution. Such solution may, in some embodiments, be prepared by combining powdered pectin (or other fiber) with additionally provided aqueous sugar components or blends thereof

The inventors observed that incorporation of all of the dry ingredients at the same time may result in incomplete dispersion of pectin within the formula. Additionally, the inventors observed that incorporation of all of the dry ingredients at the same time may have caused competition for free water, as the salt and the sugars themselves were competing with the pectin to attach to free water within the system. Accordingly, in certain preferred embodiments, pectin or other fibers may be provided in aqueous solution to avoid these issues.

The method may proceed to step 260.

As in step 260, the fiber solution may be added to the combined aqueous sugar blend containing a full spectrum of glucose, galactose, and fructose. The method may proceed to step 270.

As in step 270, the combined fiber solution and aqueous sugar blend (e.g., containing a full spectrum of glucose, galactose, and fructose) may blended together and heated. In one example, the combined ingredients may be mixed and heated to 105-114° C. to reach a final solids content of 75-85° Brix. The method may proceed to step 280.

As in step 280, the combined, the blend may be buffered using acidulants or buffers to change the pH to an appropriate level to encourage texturizing agents to modify, and in some embodiments to thicken, the formula upon cooling. The specific pH desired is dependent upon exact formula, target texture, and texturizing agent(s) utilized in the embodiment. The method may proceed to step 290.

As in step 290, the combined blend may be deposited into molds or other preferred shape/format and packaged. In some embodiments, the deposited blend may also be coated in such components as, but not limited to, sugar, acid, oil, wax, insect-derived confectionery coating, and/or artificial coatings. Such coatings may, in some embodiments, be “sanded” on and prevent the gummies/chews from sticking together or to packaging when awaiting sale and/or use. Method 200 may be considered complete

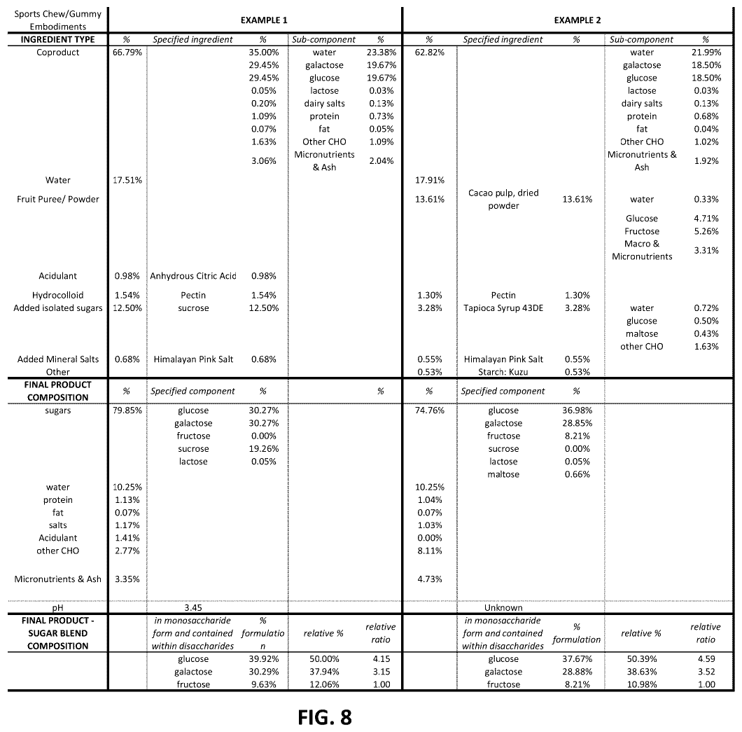

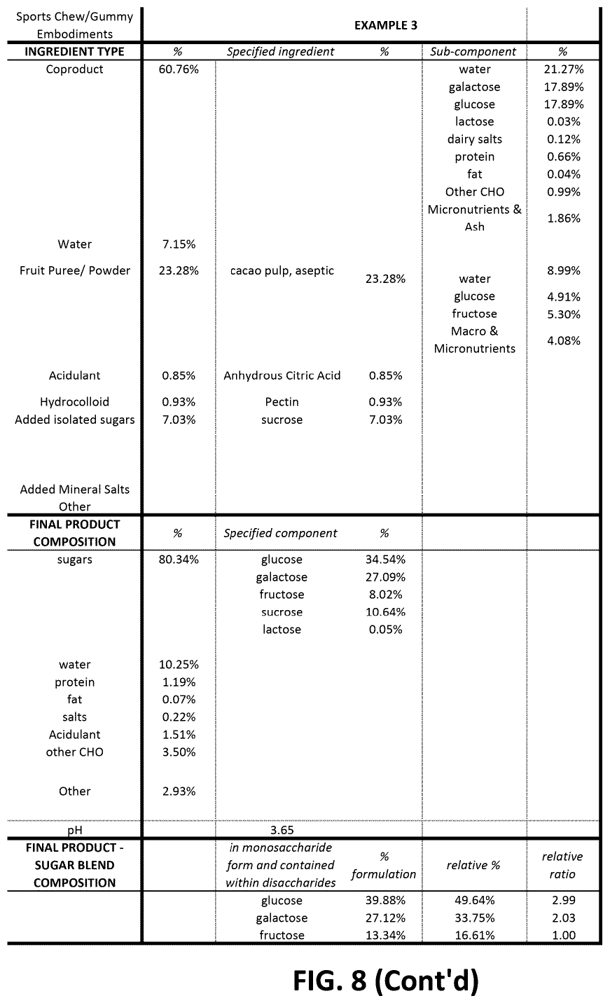

FIG. 8 provides examples of ingredients utilized for manufacturing gummies/chews and the final product composition, consistent with embodiments of method 200. It may also be noted that Example 1 utilizes sucrose as a fructose-containing component; Examples 2 and 3 utilize cacao (in different forms) as a fructose-containing component without additional isolated sugars (outside of the coproduct).

In various embodiments of gummies/chews, the sugar blend may comprise 60-98% of the total solids in the product by weight. More narrowly, the sugar blend may comprise 75-95% of the total solids by weight. More preferably, the sugar blend may comprise 86-90% of the total solids by weight.

In various embodiments of gummies/chews, hydrocolloids may comprise 0.425-3.4% of the total solids in the product by weight. More narrowly, the hydrocolloids may comprise 1.3-3.0% of the total solids by weight. More preferably, the hydrocolloids may comprise 1.7-2.5% of the total solids by weight.

In various embodiments of gummies/chews containing cacao, cacao solids (including sugars) may comprise 0-50% of the total solids in the product by weight. More narrowly, the cacao solids may comprise 0-35% of the total solids by weight. More preferably, the cacao solids may comprise 11-25% of the total solids by weight.

In various embodiments of gummies/chews, water may comprise 10-25% of total product weight. More narrowly, water may comprise 12-22% of total product weight. More preferably, water may comprise 15-20% of total product weight.

In various embodiments of gummies/chews, the pH may be between 3.0 and 3.9; more narrowly, a desired pH may be between 3.2 and 3.7; more preferably, a desired pH may be between 3.4 and 3.5. The risks of crystallization or reduced structural integrity may be increased outside these pH ranges.

### Energy Gel Embodiments and Preparation Thereof

Various energy gel embodiments may substantially comprise 30-55% lactose solids and derivatives, 0-25% fruit solids and/or added sugars, 0-4% salts and other electrolytes, 20-50% water, 0-4% hydrocolloid, and/or 0-1.5% caffeine and/or other stimulant. More narrowly, embodiments of the sports gel embodiments may substantially comprise 35-45% lactose solids and derivatives, 8-22.5% fruit solids and/or added sugars, 0.2-3% salts and other electrolytes, 35-47% water, 0.25-2.5% hydrocolloid, and/or 0.1-1.0% caffeine and/or other stimulant. More preferably, embodiments of the sports gel embodiments may substantially comprise 40-45% lactose solids and derivatives, 10-13% fruit solids and/or added sugars, 0.2-1.5% salts and other electrolytes, 40-47% water, 0.4-2.5% hydrocolloid, and/or 0.2-0.2% caffeine and/or other stimulant.

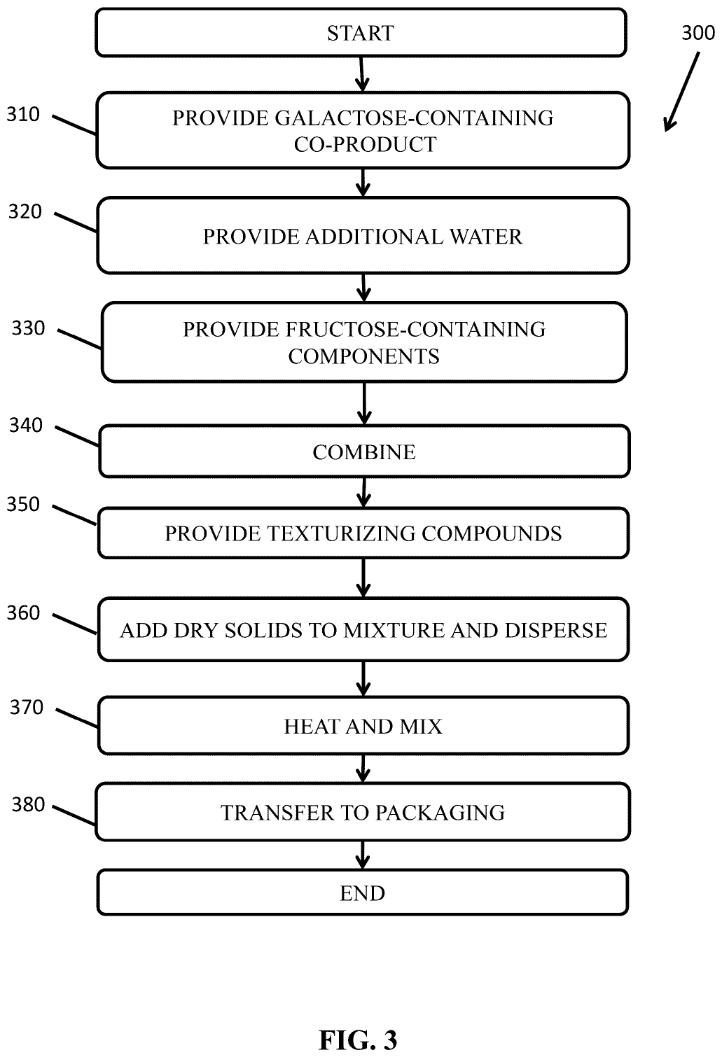

With reference to FIG. 3, an embodiment of a method 300 for preparing an energy gel is provided. As would be appreciated by one of skill in the art, portions of this and other methods disclosed herein comprise methods for manufacturing embodiments of food product with disclosed sugar blend.

As in step 310, coproduct containing galactose and glucose may be provided. This step may proceed similarly to step 210, discussed above. The method may proceed to step 320.

As in step 320, additional water may be provided to further hydrate the coproduct. The method may proceed to step 330.

As in step 330, fructose-containing components may be provided. This step may proceed similarly to step 220, discussed above. The method may proceed to step 340.

As in step 340, the provided components may be mixed. In one example, the components may be poured into a jacketed mixing tank and mixed to combine using low agitation, for example at or around 250 RPM. The method may proceed to step 350.

As in step 350, texturizers and other solids may be provided. In one example, tapioca starch, agar, and/or other solids may be provided. Such other solids may include acidulant. The method may proceed to step 360.

As in step 360, the various dry solids may be added to the solution and dispersed. In one example, the solids may be disbursed utilizing a high shear mixer. The method may proceed to step 370.

As in step 370, the mixture may be heated and further mixed. In one example, the mixture may be heated, for example to between 60° to 100° C., and stirred under low agitation for approximately 10 minutes while maintaining such temperature. However, in some embodiments, mixing may proceed at room temperature or above, provided the boiling point is not exceeded. The method may proceed to step 380.

As in step 380, the gel may be transferred to packaging. In one example, the gel is transferred while hot to a standard metallized pouch rated for ‘hot fill’ processes. Method 300 may be considered complete.

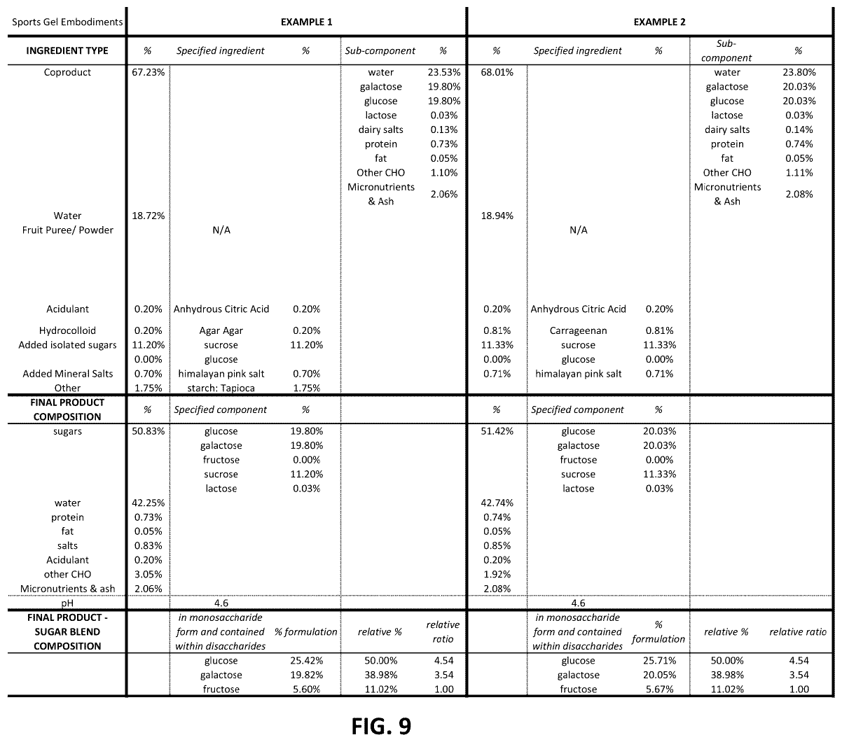

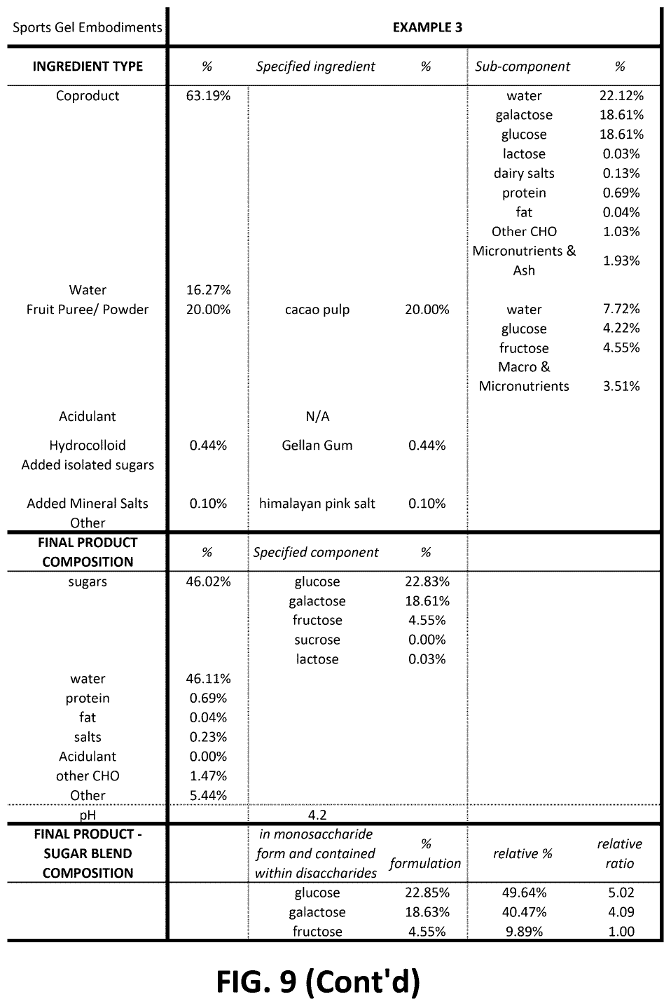

FIG. 9 provides examples of ingredients utilized for manufacturing gels and the final product composition, consistent with embodiments of method 300. It may also be noted that Examples 1 and 2 utilize isolated sugars as a fructose-containing component; Example 3 utilizes cacao pulp as a fructose-containing component without additional isolated sugars (outside of the coproduct).

In various embodiments of gels, the sugar blend may comprise 60-95% of the total solids in the product by weight. More narrowly, the sugar blend may comprise 70-90% of the total solids by weight. More preferably, the sugar blend may comprise 80-88% of the total solids by weight.

In various embodiments of gels, hydrocolloids may comprise 0-2.9% of the total solids in the product by weight. More narrowly, the hydrocolloids may comprise 0.1-0.6% of the total solids by weight. More preferably, the hydrocolloids may comprise 0.12-0.25% of the total solids by weight.

In various embodiments of gels containing cacao, cacao solids (including sugars) may comprise 0-50% of the total solids in the product by weight. More narrowly, the cacao solids may comprise 0-30% of the total solids by weight. More preferably, the cacao solids may comprise 0-20% of the total solids by weight.

In various embodiments of gels, water may comprise 30-50% of total product weight. More narrowly, water may comprise 35-45% of total product weight. More preferably, water may comprise 38-42% of total product weight.

In various embodiments of gels, the pH may be between 3.5 and 6.5; more narrowly, a desired pH may be between 4.0 and 6.0; more preferably, a desired pH may be between 4.5 and 5.5. The risks of crystallization, undesirable flavor profiles, and/or the like may be increased outside these pH ranges.

### Energy Drink Powder Embodiments and Preparation Thereof

Various energy drink powder embodiments may substantially comprise 6-90% dairy permeate solids, 2-85% fruit solids or added sugars, 0-5% additional salts and other electrolytes, and/or 0-11% caffeine and/or other stimulant. More narrowly, embodiments of the sports drink powder may substantially comprise 20-85% dairy permeate solids, 5-70% fruit solids or added sugars, 0.5-3% additional salts and other electrolytes, and/or 0.1-5% caffeine and/or other stimulant. More preferably, embodiments of the sports drink powder embodiments may substantially comprise 50-85% dairy permeate solids, 6-30% fruit solids or added sugars, 1.5-2% salts and other electrolytes, and/or 0.15-1% caffeine and/or other stimulant.

In alternative embodiments, energy drink powder embodiments may be commercially sold pre-hydrated, that is as energy drinks. In such embodiments, the ratio of water to energy drink powder may range from 4:1 to 19:1.

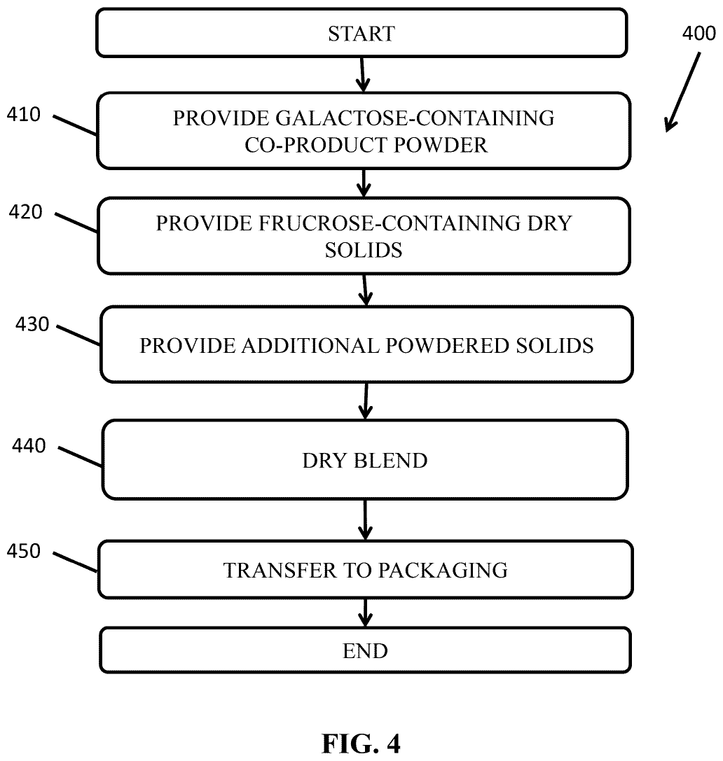

With reference to FIG. 4, an embodiment of a method 400 for preparing an energy drink powder is provided. As would be appreciated by one of skill in the art, portions of this and other methods disclosed herein comprise methods for manufacturing embodiments of food product with disclosed sugar blend.

As in step 410, a coproduct containing galactose and glucose in powdered form may be provided. This step may proceed similarly to step 210, discussed above. The method may proceed to step 420.

As in step 420, fructose-containing dry solids may be provided. In one example, such solids may include one or more dried fruit powders and/or isolated sugars. In some embodiments, crystallized cacao pulp/juice/puree may be included. In preferred embodiments, sucrose in the form of cane sugar may be included. The method may proceed to step 430.

As in step 430, additional powdered solids may optionally be provided. Such solids may include other carbohydrate-containing ingredients such as glucose or dextrins, salts, other electrolytes, vitamins, stimulants, acidulants, flavorings, and/or the like. The method may proceed to step 440.

As in step 440, the provided components may be dry blended. Preferably such blending continues until the provided components achieve substantial homogeneity. The method may proceed to step 450.

As in step 450, the mixed powder may be transferred to packaging. In one embodiment, standard metalized sachet pouches are filled with the powder. Method 400 may be considered complete.

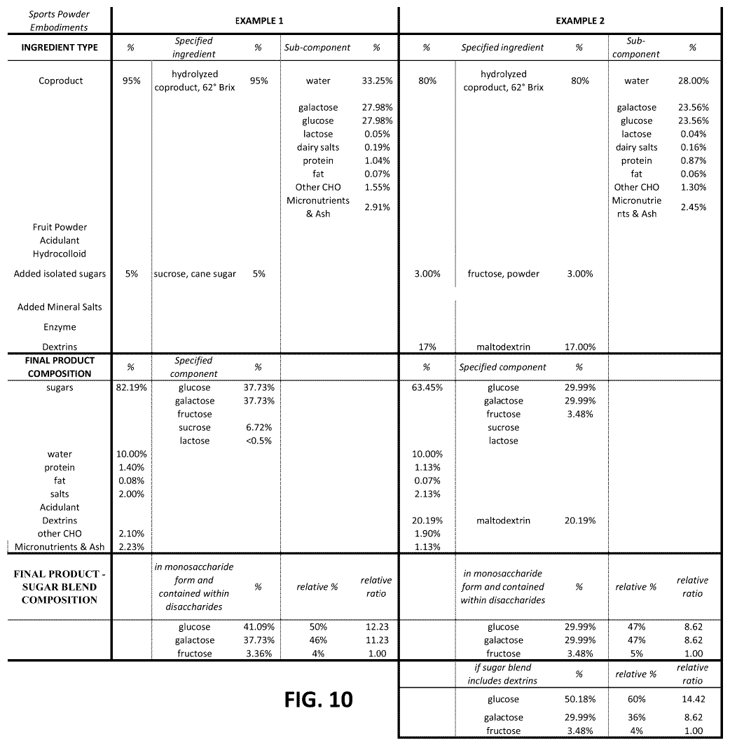

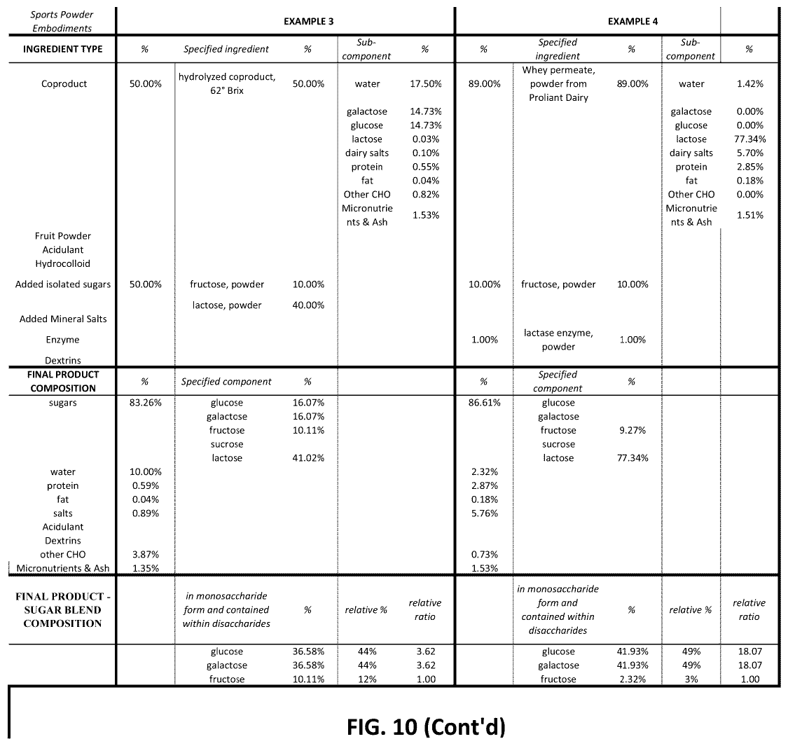

FIG. 10 provides examples of ingredients utilized for manufacturing gels and the final product composition, consistent with embodiments of method 300. It may also be noted that Example 4 illustrates an alternative embodiment where lactose is unhydrolyzed, but powdered lactase enzyme is provided; in such embodiments, hydrolysis may begin upon hydration of the drink powder. It should also be noted that Example 2 includes maltodextrin, a short polysaccharide comprising glucose, as an ingredient. At the bottom of the chart, the relative percentages of glucose, galactose, and fructose are provided in two contexts for illustrative purposes. First, the percentages are provided under the preferred definition of sugar blend, as substantially used throughout this disclosure. Below that, the alternative definition of sugar blend, which includes dextrins as well as monosaccharides and disaccharides.

In various embodiments of drink powder, the sugar blend may comprise 50-95% of the product by weight. More narrowly, the sugar blend may comprise 70-90% of the product by weight. More preferably, the sugar blend may comprise 80-88% of the product by weight.

In various embodiments of drink powder containing cacao, cacao solids (including sugars) may comprise 0-60% of the product by weight. More narrowly, the cacao solids may comprise 0-10% of the product by weigh weight. More preferably, the cacao solids may comprise 0-25% of the product by weight.

Additional Uses and Embodiments Multiple formats may leverage the disclosed sugar blend, product, and coproduct embodiments. Such formats may vary based on their texture, serving size, convenience, macronutrient/micronutrient profiles, and/or the like. During exercise, small format products that are convenient to eat while actively exercising may be preferred. Examples may include energy gels and energy chews, as discussed above. Dry drink mixes can be designed for endurance preparation, during exercise, recovery, and/or for daily wellness consumption, mainly based on macronutrient electrolyte composition and serving size. For example, the dry drink mix described herein, when combined with additional animal- or plant-based protein, could provide energy and other essential nutrition for non-endurance exercise, such as weight lifting, where protein may be highly desired by the consumer. As noted above, pre-hydrated beverages utilizing embodiments of the disclosed sugar blend could be leveraged for hydration and energy in endurance scenarios, including before, during, and after exercise. It is also contemplated that powdered formats could be used as a ingredients in other products such as energy bars, drinks, baked goods, and/or the like.

While this disclosure primarily addresses on benefits of disclosed embodiments in endurance sports and athletic activities, other applications are specifically contemplated. For example, as a dry product, the coproduct, sugar blend, and/or drink mix can easily be distributed to vulnerable populations for humanitarian purposes such as emergency nutrition in disaster situations. As another example, a dry powder could easily be transported in scenarios where high nutrient density in compact formats is ideal, such as space travel or in the armed forces. The disclosed embodiments may also be useful in clinical applications, such as for diabetics. Additionally, electrolyte- and energy-containing beverages may be consumed to help during minor illnesses, or after consumption of alcohol, to help replenish the body with rapid hydration, electrolytes, and vitamins.

Although the foregoing embodiments have been described in detail by way of illustration and example for purposes of clarity of understanding, it will be readily apparent to those of ordinary skill in the art in light of the description herein that certain changes and modifications may be made thereto without departing from the spirit or scope of the disclosure. It is also to be understood that the terminology used herein is for the purpose of describing particular aspects only, and is not intended to be limiting, since the scope of the present invention will be limited only by claims.

It is noted that, as used herein, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only,” and the like in connection with the recitation of claim elements, or use of a “negative” limitation. As will be apparent to those of ordinary skill in the art upon reading this disclosure, each of the individual aspects described and illustrated herein has discrete components and features which may be readily separated from or combined with the features of any of the other several aspects without departing from the scope or spirit of the disclosure. Any recited method can be carried out in the order of events recited or in any other order that is logically possible. Accordingly, the preceding merely provides illustrative examples. It will be appreciated that those of ordinary skill in the art will be able to devise various arrangements which, although not explicitly described or shown herein, embody the principles of the disclosure and are included within its spirit and scope.

Furthermore, all examples and conditional language recited herein are principally intended to aid the reader in understanding the principles of the invention and the concepts contributed by the inventors to furthering the art, and are to be construed without limitation to such specifically recited examples and conditions. Moreover, all statements herein reciting principles and aspects of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary configurations shown and described herein.

In this specification, various preferred embodiments have been described with reference to the accompanying drawings. It will be apparent, however, that various other modifications and changes may be made thereto and additional embodiments may be implemented without departing from the broader scope of this disclosure. The specification and drawings are accordingly to be regarded in an illustrative rather than restrictive sense.

We claim:

1. A food product comprising:
a sugar blend, the sugar blend comprising at least 50% of solids in the food product by weight;
no measurable fat content, or fat content consisting of less than 2% of solids in the food product by weight; and
no measurable protein content, or protein content consisting of less than 8% of solids in the food product by weight,
electrolytes, the electrolytes comprising between 0.5% and 6% of solids in the food product by weight, and
at least one stimulant;
wherein:
the sugar blend comprises galactose, glucose, and fructose in their respective monosaccharide forms or contained within disaccharides,
galactose, including monosaccharide galactose and galactose bound in a disaccharide comprises at least 1% of the sugar blend by weight;
glucose, including monosaccharide glucose and glucose bound in a disaccharide, comprises at least 1% of the sugar blend by weight; and
fructose, including monosaccharide fructose and fructose bound in a disaccharide, comprises at least 1% of the sugar blend by weight;
wherein the ratio of galactose to lactose in the food product is at least about 199:1 by molarity;
wherein between about 20% and about 70% of the sugar blend consists of glucose, including monosaccharide glucose and glucose bound in a disaccharide, by weight;
between about 20% and about 70% of the sugar blend consists of galactose, including monosaccharide galactose and galactose bound in a disaccharide, by weight; and
between about 5% and 40% of the sugar blend consists of fructose, including monosaccharide fructose and fructose bound in a disaccharide, by weight.

2. The food product of claim 1, wherein:
the electrolytes comprise dairy minerals naturally occurring in dairy permeate.

3. The food product of claim 2, further comprising:
fruit solids derived from cacao pulp.

4. The food product of claim 1, wherein between about 0% and about 30% of the sugar blend consists of sucrose by weight.

5. The food product of claim 1, wherein:
between about 40% and about 60% of the sugar blend consists of glucose, including monosaccharide glucose and glucose bound in a disaccharide, by weight;
between about 30% and about 45% of the sugar blend consists of galactose, including monosaccharide galactose and galactose bound in a disaccharide, by weight; and
between about 4% and about 20% of the sugar blend consists of fructose, including monosaccharide fructose and fructose bound in a disaccharide, by weight.

6. The food product of claim 5, wherein:
between about 47% and about 53% of the sugar blend consists of glucose, including monosaccharide glucose and glucose bound in a disaccharide, by weight;
between about 36% and about 42% of the sugar blend consists of galactose, including monosaccharide galactose and galactose bound in a disaccharide, by weight; and
between about 8% and about 14% of the sugar blend consists of fructose, including monosaccharide fructose and fructose bound in a disaccharide, by weight.

7. The food product of claim 6, further comprising:
water, the water comprising between about 10% and about 25% of the food product by weight; and
hydrocolloids, the hydrocolloids comprising between about 0.425% and about 3.4% of solids within the food product by weight, and
cacao fruit solids
wherein: the ratio of galactose to lactose in the food product is at least about 19:1 by molarity.

8. The food product of claim 6, further comprising:
water, the water comprising between about 30% and about 50% of the food product by weight; and
hydrocolloids, the hydrocolloids comprising between about 0% and about 2.9% of solids in the food product by weight,
cacao fruit solids,
wherein: the ratio of galactose to lactose in the food product is at least about 19:1 by molarity.

9. The food product of claim 1, further comprising:
cacao fruit solids,
water, wherein the ratio of water to solids is between about 4:1 and about 19:1,
wherein the food product is a dry powder,
wherein: the ratio of galactose to lactose in the food product is at least about 19:1 by molarity.

10. A method of manufacturing a coproduct for a food product or coproduct thereof, the method comprising:
providing a portion of permeate, the permeate containing a first portion of lactose;
providing a second portion of lactose;
combining the portion of permeate with the second portion of lactose into a blend;
agitating the blend;
pasteurizing the blend;
adding lactase enzyme to the blend;
hydrolyzing at least 95% of the lactose in the blend into glucose monosaccharide and galactose monosaccharide; and
pasteurizing the blend into the coproduct.

11. The method of claim 10, wherein the step of providing the portion of permeate further comprises: providing a portion of whey permeate powder, milk permeate powder, or a combination thereof;
providing a portion of water; and
hydrating the dry permeate powder with the portion of water to achieve a permeate solution comprising between about 60% and about 70% water by weight.

12. The method of claim 10, wherein the step of providing a portion of lactose further comprises:
providing a portion of dry lactose powder;
providing a second portion of permeate, the second portion of permeate having a liquid form; and
hydrating the portion of dry lactose powder with the second portion of permeate.

13. The method of claim 10, wherein the step hydrolyzing at least 95% of the lactose into glucose monosaccharide and galactose monosaccharide further comprises:
hydrolyzing at least 98% of the lactose into glucose monosaccharide and galactose monosaccharide.

14. The method of claim 13, wherein the step of adding lactase enzyme to the combination further comprises:
providing a beta-galactosidase enzyme as the lactase enzyme,
wherein the step of providing the beta-galactosidase enzyme as the lactase enzyme further comprises:
providing a portion of NOLA FIT 5500 produced by CHR Hansen as the beta-galactosidase enzyme;
wherein the ratio of lactose to beta-galactosidase enzyme, based on molarity, is between about 65:1 and about 10:1.

15. The method of claim 14, wherein the step of hydrolyzing at least 98% of the lactose into glucose monosaccharide and galactose monosaccharide further comprises:
agitating the pasteurized mixture under 200-300 RPM agitation at about 30° C.-about 40° C. for at least 7 hours.

16. The method of claim 15, wherein the step of hydrolyzing the lactose into glucose monosaccharide and galactose monosaccharide further comprises:
agitating the pasteurized mixture under about 225-about 275 RPM agitation at about 33° C.-about 42° C. for at least 10 hours,
wherein the step hydrolyzing at least 98% of the lactose into glucose monosaccharide and galactose monosaccharide further comprises:
hydrolyzing at least 99.5% of the lactose into glucose monosaccharide and galactose monosaccharide.

17. The method of claim 10, further comprising:
providing a portion of additional sugar, the portion of additional sugar comprising at least one of sucrose and fructose; and
combining the portion of additional sugar with the coproduct, such that the monosaccharide and disaccharide content of the combination comprises a sugar blend containing:
between about 20% and about 70% of the sugar blend consists of glucose, including monosaccharide glucose and glucose bound in a disaccharide, by weight;
between about 20% and about 70% of the sugar blend consists of galactose, including monosaccharide galactose and galactose bound in a disaccharide, by weight; and
between about 5% and about 40% of the sugar blend consists of galactose, including monosaccharide galactose and galactose bound in a disaccharide, by weight.

18. The method of claim 17 wherein further the sugar blend contains:
between about 40% and about 60% of the sugar blend consists of glucose, including monosaccharide glucose and glucose bound in a disaccharide, by weight;
between about 30% and about 45% of the sugar blend consists of galactose, including monosaccharide galactose and galactose bound in a disaccharide, by weight; and
between about 4% and about 20% of the sugar blend consists of fructose, including monosaccharide fructose and fructose bound in a disaccharide, by weight.

19. The method of claim 10, further comprising:
providing a portion of fructose-containing components;
combining the portion of fructose-containing components with the coproduct to form a mixture;
reducing the mixture;
providing a fiber solution;
combining, blending, and heating the fiber solution and the reduced mixture; and
depositing the combined, blended, and heated material into molds.

20. The method of claim 19 wherein further:
the step of providing a portion of fructose components further comprises providing a portion of cacao fruit solids.

21. The method of claim 10, further comprising:
providing a portion of fructose-containing components;
combining the portion of fructose-containing components with the coproduct;
providing a portion of texturizing compounds;
dispersing the texturizing compounds into the combination of fructose-containing components and coproduct;
mixing the combination with dispersed texturizing compounds to form the food product; and
depositing the food product into at least one metallized pouch.

22. The method of claim 10, further comprising:
providing a portion of fructose-containing components, the fructose containing components comprising a first portion of dry solids
providing a second portion of dry solids; and
dry mixing the powder coproduct, the first portion of dry solids, and the second portion of dry solids.
